(19) United States
(12) Patent Application Publication
(10) Pub. No.: US 2010/0062939 A1
(43) Pub. Date: Mar. 11, 2010

(54) Herbicide/Safener Combination Comprising Dimethoxytriazinyl-Substituted Difluoromethanesulfonylanilides

(75) Inventors: Erwin Hacker, Hochheim (DE); Christopher Hugh Rosinger, Hofheim (DE); Chieko Ueno, Frankfurt (DE); Georg Bonfig-Picard, Rodenbach (DE); Frank Ziemer, Kriftel (DE); Shinichi Shirakura, Oyama-shi (JP)

Correspondence Address: Baker Donelson Bearman, Caldwell & Berkowitz, PC, 555 Eleventh Street, NW, Sixth Floor, Washington, DC, 20004, US

(73) Assignee: BAYER CROPSCIENCE AG, Monheim (DE)

(21) Appl. No.: 12/539,532

(22) Filed: Aug. 11, 2009

(30) Foreign Application Priority Data
Aug. 14, 2008 (DE) 102008037627.2

(51) Int. Cl. A01N 25/32; A01P 13/00

(52) U.S. Cl. 504/106; 504/103; 504/108; 504/112; 504/104

(57) ABSTRACT

The present invention relates to a herbicide/safener combination comprising components (A) and (B), where
(A) denotes one or more compounds or salts thereof from the group described by the general formula (I):

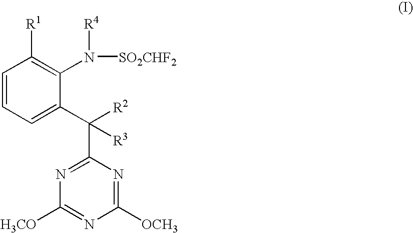

in which
R¹ is halogen, preferably fluorine or chlorine,
R² is hydrogen and R³ is hydroxyl or
R² and R³ together with the carbon atom to which they are attached are a carbonyl group C═O and
R⁴ is hydrogen or methyl;
   and
(B) is one or more compounds from the group of the safeners.

The present invention relates to the technical field of crop protection compositions, in particular herbicide/safener combinations, which are highly suitable for use against harmful plants in crops of useful plants, and which can be employed, for example (e.g.), by the pre-sowing method (with or without incorporation), by the pre-emergence method or by the post-emergence method in sown and/or planted crop plants such as, for example, in wheat (durum wheat and common wheat), corn, soybeans, sugar beet, sugar cane, cotton, rice (planted or sown under upland or paddy conditions using indica and/or japonica varieties and also hybrids/mutants/GMOs), beans (such as, for example, bush beans and broad beans), flax, barley, oats, rye, triticale, oilseed rape, potatoes, millet (sorghum), pasture grass, greens/lawns, in fruit plantations (plantation crops) or on non-crop areas (for example squares of residential areas or industrial sites, rail tracks). In addition to the single application, sequential applications are also possible.

It relates to a combination comprising at least one herbicide from the group of the N-{2-[4,6-dimethoxy-(1,3,5)triazine-2-(carbonyl- or -hydroxymethyl)]-6-halophenyl}-difluoromethanesulfonamides or their N-methyl derivatives and/or their salts, hereinbelow also referred to as “dimethoxytriazinyl-substituted difluoromethanesulfonylanilides”, and at least one active compound from the group of the safeners.

It is known that cyclicly substituted sulfonamides have herbicidal properties (for example WO 93/09099 A2, WO 96/41799 A1). These also include the phenyldifluoromethanesulfonamides, which are also referred to as difluoromethanesulfonylanilides. The lastmentioned compounds are, for example, phenyl derivatives which are mono- or polysubstituted, inter alia by dimethoxypyrimidinyl (for example WO 00/006553 A1) or dimethoxytriazinyl and also a further halogen substitution (for example WO 2005/096818 A1, WO 2007/031208 A2).

Specific compounds from the group of the N-{2-[4,6-dimethoxy-(1,3,5)triazine-2-(carbonyl- or -hydroxymethyl)]-6-halophenyl}difluoromethanesulfonamides, as described in WO 2005/096818 A1, and their N-methyl derivatives, as described for the first time in WO 2006/008159 A1 in connection with fungicides and in WO 2007/031208 A2 and JP 2007-213330 (unpublished) as herbicides, have, as active compounds, good herbicidal properties.

The herbicidal activity of the dimethoxytriazinyl-substituted difluoromethanesulfonylanilides against harmful plants (broad-leaved weeds, weed grasses, Cyperaceae; hereinbelow collectively also referred to as “weed”) is already at a high level, but depends in general on the application rate, the formulation in question, the harmful plants to be controlled in each case or the spectrum of harmful plants, the climatic and soil conditions and the like. Further criteria in this context are duration of action, or the breakdown rate, of the herbicide, the general speed of action (more rapid onset of action), the activity spectrum and behavior toward follower crops (replanting problems) or the general flexibility of application (control of weeds in their various growth stages).

However, some of these herbicidally active compounds are not fully compatible with some important crop plants, such as, for example, in wheat (durum wheat and common wheat), corn, soybeans, sugar beet, sugar cane, cotton, rice (planted or sown under upland or paddy conditions using indica and/or japonica varieties and also hybrids/mutants/GMOs), beans (such as, for example, bush beans and broad beans), flax, barley, oats, rye, triticale, oilseed rape, potatoes, millet (sorghum), pasture grass, greens/lawns or in fruit plantations (plantation crops). Accordingly, in some crops, they can not be used such that the desired broad herbicidal activity against harmful plants is ensured, which, in addition to single applications, also includes sequential applications.

A possible solution to the problems mentioned above may be to provide herbicide/safener combinations, that is mixtures of herbicides and safeners and also other components from the group of the agrochemically active compounds of a different type and/or of formulation auxiliaries and additives customary in crop protection, which may provide the desired crop plant compatibility. However, in the combined use of a plurality of active compounds, there are frequently phenomena of chemical, physical or biological incompatibility, for example lack of stability of a joint formulation, decomposition of an active compound or antagonism in the biological activity of the active compounds. For these reasons, potentially suitable combinations have to be selected in a targeted manner and tested experimentally for their suitability, it not being possible to safely discount a priori negative or positive results.

Mixtures of non-N-methyl derivatives of the compounds mentioned above with other herbicidally active compounds are known in principle (for example WO 2007/079965 A2); however, their effectiveness in mixtures with other herbicides has only been confirmed in individual cases for dimethoxypyrimidinyl-substituted phenyl derivatives. In addition, there are also mixtures of selected N-methyl derivatives of the compounds mentioned above with some combination partners (PCT/EP2008/000870, unpublished). Here, as in WO 2007/031208 A2, the potential addition of some selected compounds from the group of the safeners is mentioned, but not supported.

It was an object of the present invention to provide herbicidal compositions, superior to the prior art, in which the compatibility of the abovementioned herbicides with important crop plants is increased, thus ensuring a selective use.

Surprisingly, it has now been found that this object can be achieved by herbicide/safener combinations of dimethoxytriazinyl-substituted difluoromethanesulfonylanilides in combination with compounds (active substances) from the group of the safeners which act together in a particularly favorable manner, for example when they are used for controlling unwanted vegetation in crop plants such as wheat (durum wheat and common wheat), corn, soybeans, sugar beet, sugar cane, cotton, rice (planted or sown under upland or paddy conditions using indica and/or japonica varieties and also hybrids/mutants/GMOs), beans (such as, for example, bush beans and broad beans), flax, barley, oats, rye, triticale, oilseed rape, potatoes, millet (sorghum), pasture grass, greens/lawns or in fruit plantations (plantation crops), in particular in rice crops (planted or sown under upland or paddy conditions using indica and/or japonica varieties and also hybrids/mutants/GMOs).

Accordingly, the present invention provides a herbicide/safener combination comprising components (A) and (B), where
(A) denotes one or more compounds or salts thereof from the group described by the general formula (I):

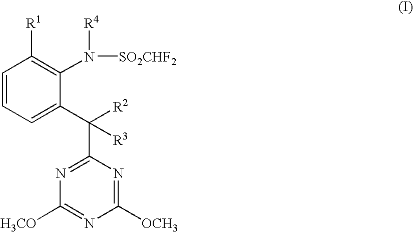

in which
R¹ is halogen, preferably fluorine or chlorine,
R² is hydrogen and R³ is hydroxyl or
R² and R³ together with the carbon atom to which they are attached are a carbonyl group C═O and
R⁴ is hydrogen or methyl;
   and
(B) is one or more compounds from the group of the safeners.

The herbicide/safener combinations according to the invention may additionally comprise further components: for example agrochemically active compounds of a different type and/or formulation auxiliaries and/or additives customary in crop protection, or they may be employed together with these. Hereinbelow, the use of the term “herbicide/safener combination(s)” or “combination(s)” also includes the “herbicidal compositions” formed in this manner.

Hereinbelow, the terms “herbicide(s)”, “safener(s)”, “individual herbicide(s)”, “compound(s)” or “active compound(s)” are also used synonymously for the term “components(s)” or “individual component(s)” in the context.

The compounds of the formula (I) are capable of forming salts. The salt formation may take place by allowing a base to act on those compounds of the formula (I) carrying an acidic hydrogen atom. Suitable bases are, for example, organic amines, such as trialkylamines, morpholine, piperidine or pyridine, and also ammonium, alkali metal or alkaline earth metal hydroxides, carbonates and bicarbonates, in particular sodium hydroxide and potassium hydroxide, sodium carbonate and potassium carbonate and sodium bicarbonate and potassium bicarbonate, alkali metal or alkaline earth metal alkoxides, in particular sodium methoxide, ethoxide, n-propoxide, isopropoxide, n-butoxide or t-butoxide or potassium methoxide, ethoxide, n-propoxide, isopropoxide, n-butoxide or t-butoxide. These salts are compounds in which the acidic hydrogen is replaced by an agriculturally suitable cation, for example metal salts, in particular alkali metal salts or alkaline earth metal salts, especially sodium salts or potassium salts, or else ammonium salts, salts with organic amines or quaternary ammonium salts, for example with cations of the formula [NRR′R″R′″]⁺in which R to R′″ are in each case independently of one another organic radicals, in particular alkyl, aryl, arylalkyl or alkylaryl. Also suitable are alkylsulfonium and alkylsulfoxonium salts, such as (C₁-C₄)-trialkylsulfonium and (C₁-C₄)-trialkylsulfoxonium salts. By a suitable inorganic or organic acid, such as, for example, mineral acids such as, for example, HCl, HBr, H₂SO₄, H₃PO₄ or HNO₃, or organic acids, for example carboxylic acids such as formic acid, acetic acid, propionic acid, oxalic acid, lactic acid or salicylic acid or sulfonic acids, such as, for example, p-toluenesulfonic acid, forming an adduct with a basic group such as, for example, amino, alkylamino, dialkylamino, piperidino, morpholino or pyridino, the compounds of the formula (I) are also capable of forming salts. These salts then contain the conjugated base of the acid as anion.

Preferred components (A) are the following compounds (A-1) to (A-8) of the formulae (A1), (A2), (A3), (A4), (A5), (A6), (A7) and (A8) or their salts:

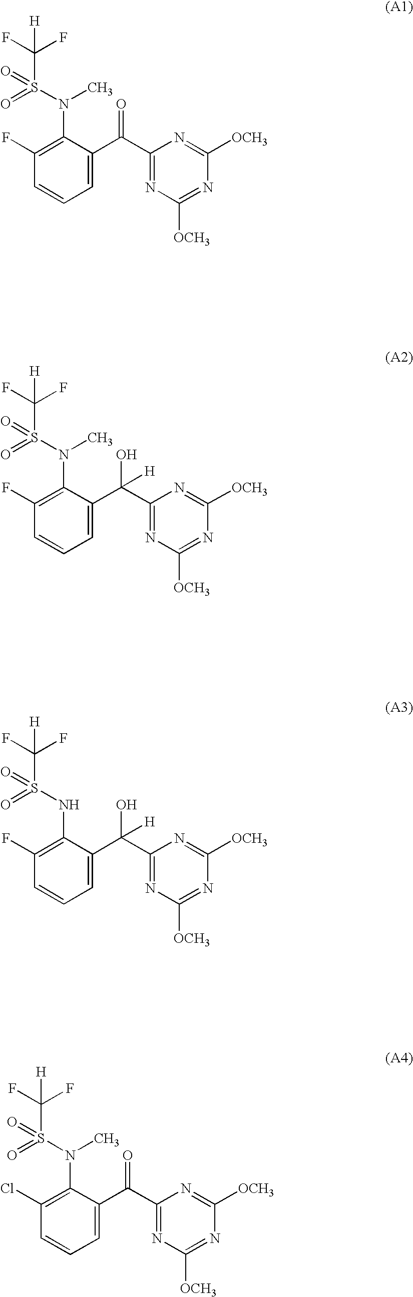

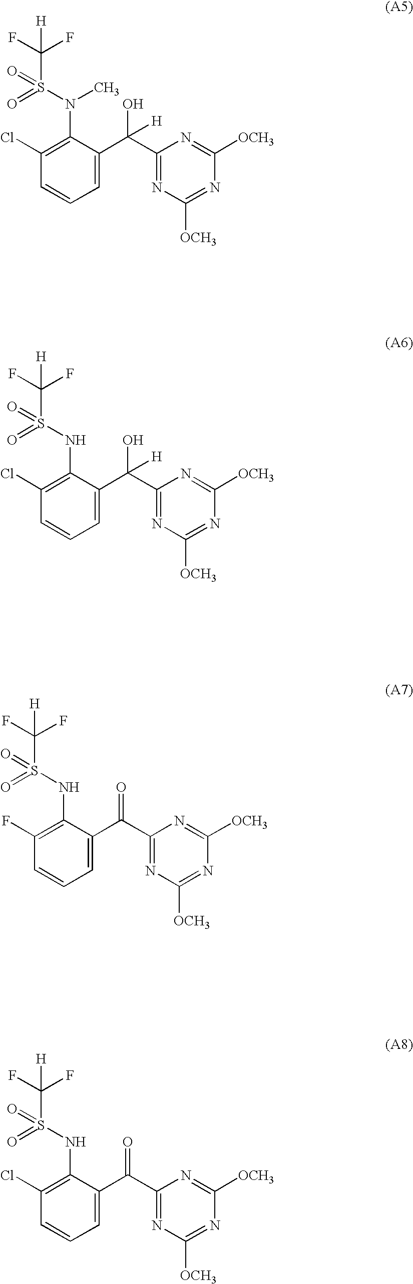

Particularly preferred as components (A) are the compounds (A-1), (A-2) and (A-3).

The formula (I) mentioned embraces all stereoisomers and their mixtures, in particular also racemic mixtures, and—if enantiomers are possible—the respective enantiomer which is biologically active. This also applies to possible rotamers of the formula (I).

The herbicides of group (A) inhibit mainly the enzyme acetolactate synthase (ALS) and thus the protein biosynthesis in plants. The application rate of the herbicides (A) can vary within a wide range, for example between 0.1 g and 1000 g of AS/ha (hereinbelow, AS/ha means “active substance per hectare”=based on 100% pure active compound). Applied at application rates of from 0.1 g to 1000 g of AS/ha, the herbicides (A), preferably the compounds (A-1) to (A-8), control, when used in the pre-sowing pre-planting or the pre- and post-emergence method, a relatively wide spectrum of harmful plants, for example of annual and perennial mono- or dicotyledonous broad-leaved weeds, weed grasses and Cyperaceae, and also of unwanted crop plants. For the combinations according to the invention, the application rates are generally in the range of from 0.1 g to 500 g of AS/ha, preferably from 0.5 g to 200 g of AS/ha, particularly preferably from 1.0 g to 150 g of AS/ha.

The safeners comprised as component (B) are compounds which are suitable for reducing the phytotoxic effects of crop protection agents such as herbicides on crop plants.

Of particular interest here is the selective control of harmful plants in crops of useful plants and ornamental plants. Although the herbicides (A) have already demonstrated good to sufficient selectivity in a large number of crops, in principle, in some crops and in particular also in the case of mixtures with other, less selective, herbicides, phytotoxicities on the crop plants may occur. In this respect, safeners of particular interest are those which, on their own or together with other safeners, can be employed in an antidotically effective amount to reduce the phytotoxic side-effects of the herbicides/pesticides employed, for example in economically important crops such as wheat (durum wheat and common wheat), corn, soybeans, sugar beet, sugar cane, cotton, rice, beans (such as, for example, bush beans and broad beans), flax, barley, oats, rye, triticale, oilseed rape, potatoes, millet (sorghum), pasture land, greens/lawns or in fruit plantations (plantation crops), in particular in rice crops (planted or sown under upland or paddy conditions using indica and/or japonica varieties and also hybrids/mutants/GMOs).

Unless specifically defined otherwise, the following definitions generally apply to the radicals of the formulae (S-1) to (S-13) below.

In all of the formulae (S-1) to (S-13) mentioned below, the radicals alkyl, alkoxy, haloalkyl, haloalkoxy, alkylamino, alkylthio, haloalkylthio, alkylsulfinyl, alkylsulfonyl, haloalkylsulfinyl and haloalkylsulfonyl and the corresponding unsaturated and/or substituted radicals can in each case be straight-chain or branched in the carbon skeleton. Unless indicated specifically, preference is given for these radicals to the lower carbon skeletons, for example those having 1 to 6 carbon atoms, especially 1 to 4 carbon atoms, or in the case of unsaturated groups having 2 to 6 carbon atoms, especially 2 to 4 carbon atoms. Alkyl radicals, both alone and in composite definitions such as alkoxy, haloalkyl, etc., are for example methyl, ethyl, n-propyl or isopropyl, n-butyl, isobutyl, tert-butyl or 2-butyl, pentyls, hexyls, such as n-hexyl, isohexyl, and 1,3-dimethylbutyl, heptyls, such as n-heptyl, 1-methylhexyl, and 1,4-dimethylpentyl; alkenyl and alkynyl radicals have the definition of the possible unsaturated radicals corresponding to the alkyl radicals; at least one double bond or triple bond is present, preferably one double bond or triple bond, respectively. Alkenyl is for example vinyl, allyl, 1-methylprop-2-en-1-yl, 2-methylprop-2-en-1-yl, but-2-en-1-yl, but-3-en-1-yl, 1-methylbut-3-en-1-yl, and 1-methylbut-2-en-1-yl; alkynyl is for example ethynyl, propargyl, but-2-yn-1-yl, but-3-yn-1-yl, and 1-methylbut-3-yn-1-yl.

Halogen is fluorine, chlorine, bromine or iodine. Haloalkyl, haloalkenyl, and haloalkynyl are alkyl, alkenyl or alkynyl, respectively, which are fully or partly substituted by halogen, preferably by fluorine, chlorine or bromine, in particular by fluorine and/or chlorine, examples being monohaloalkyl (i.e., monohalogenalkyl), perhaloalkyl, CF₃, CHF₂, CH₂F, CF₃CF₂, CH₂FCHCl, CCl₃, CHCl₂, CH₂CH₂Cl; haloalkoxy is for example OCF₃, OCHF₂, OCH₂F, CF₃CF₂O, OCH₂CF₃, and OCH₂CH₂Cl; this correspondingly applies to haloalkenyl and other halogen-substituted radicals.

Aryl is a monocyclic, bicyclic or polycyclic aromatic system, phenyl or naphthyl for example, preferably phenyl.

A heterocyclic radical or ring (heterocyclyl or heteroaryl) can be saturated, unsaturated or heteroaromatic; unless otherwise defined, it preferably comprises one or more, especially 1, 2 or 3 heteroatoms in the heterocyclic ring, preferably from the group of N, O, and S; preferably it is an aliphatic heterocyclyl radical having 3 to 7 ring atoms or a heteroaromatic radical having 5 or 6 ring atoms. The heterocyclic radical may for example be a heteroaromatic radical or ring (heteroaryl), such as a monocyclic, bicyclic or polycyclic aromatic system in which at least 1 ring contains one or more heteroatoms. Preferably it is a heteroaromatic ring with a heteroatom from the group of N, O, and S, such as pyridyl, pyrrolyl, thienyl or furyl, for example; with further preference it is a corresponding heteroaromatic ring having 2 or 3 heteroatoms, such as pyrimidinyl, pyridazinyl, pyrazinyl, triazinyl, thiazolyl, thiadiazolyl, oxazolyl, isoxazolyl, pyrazolyl, imidazolyl, and triazolyl. Furthermore preferably it is a partially or fully hydrogenated heterocyclic radical having a heteroatom from the group of N, O, and S, such as oxiranyl, oxetanyl, oxolanyl (=tetrahydrofuryl), oxanyl, pyrrolidyl (=pyrrolidinyl) or piperidyl or else pyrrolinyl such as Δ¹-pyrrolinyl, Δ²-pyrrolinyl or Δ³-pyrrolinyl, e.g., Δ¹-pyrrolin-2-yl, Δ¹-pyrrolin-3-yl, Δ¹-pyrrolin-4-yl or Δ¹-pyrrolin-5-yl or Δ²-pyrrolin-1-yl, Δ²-pyrrolin-2-yl, Δ²-pyrrolin-3-yl, Δ²-pyrrolin-4-yl, Δ²-pyrrolin-5-yl or Δ³-pyrrolin-1-yl, Δ³-pyrrolin-2-yl or Δ³-pyrrolin-3-yl.

With further preference it is a partially or fully hydrogenated heterocyclic radical having 2 heteroatoms from the group of N, O, and S, for example

piperazinyl, dioxanyl, dioxolanyl, oxazolinyl, isoxazolinyl, oxazolidinyl, isoxazolidinyl and morpholinyl.

By the formulation to the effect that, in the case of substituted aryl and heteroaryl radicals, “alkyl, alkoxy or haloalkoxy radicals are, if desired, linked cyclically to one another, with the proviso that they are in ortho position” is meant, for example, the groups benzo-1,4-dioxanyl, 1,3-benzodioxolyl, chromanyl, 3,4-dihydro-1H-chromanyl, 2,3-dihydro-1-benzofuran, 1,3-dihydro-1-benzofuranyl, indanyl, 1,2,3,4-tetrahydronaphthyl, and their analogs with halogenation, especially fluorination, on the saturated carbon units.

Suitable substituents for a substituted heterocyclic radical are the substituents specified later on below, and oxo as well. The oxo group may also occur on the hetero-ring atoms which are able to exist in different oxidation states, as in the case of N and S, for example.

The definition “substituted by one or more radicals” refers, unless otherwise defined, to one or more identical or different radicals.

The substituents given by way of example (“first substituent level”) can, if they include hydrocarbon-containing fractions, be further substituted therein if desired (“second substituent level”), by for example one of the substituents as defined for the first substituent level. Corresponding further substituent levels are possible. The term “substituted radical” preferably embraces just one or two substituent levels.

In the case of radicals having carbon atoms preference is given to those having 1 to 6 carbon atoms, preferably 1 to 4 carbon atoms, particularly 1 or 2 carbon atoms. Preference is generally given to substituents from the group of halogen, such as fluorine and chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro, and cyano.

Unsubstituted or substituted phenyl is preferably phenyl which is unsubstituted or substituted one or more times, preferably up to three times, by identical or different radicals from the group of halogen, (C₁-C₄)-alkyl, (C₁-C₄)-alkoxy, (C₁-C₄)-haloalkyl, (C₁-C₄)-haloalkoxy, and nitro, examples being o-, m-, and p-tolyl, dimethylphenyls, 2-, 3-, and 4-chlorophenyl, 2-, 3-, and 4-trifluoromethyl- and 2-, 3-, and 4-trichloromethylphenyl, 2,4-, 3,5-, 2,5-, and 2,3-dichlorophenyl, and o-, m-, and p-methoxyphenyl.

An acid radical of an organic or inorganic oxygen acid is a radical formed formally by removal of a hydroxyl group from the acid function, an example being the sulfo radical —SO₃H, which is derived from sulfuric acid H₂SO₄, or the sulfino radical —SO₂H, which is derived from sulfurous acid H₂SO₃, or, correspondingly, the group SO₂NH₂, the phospho radical PO(OH)₂, the group —PO(NH₂)₂, —PO(OH)(NH₂), —PS(OH)₂, —PS(NH₂)₂ or —PS(OH)(NH₂), the carboxyl radical COOH, which is derived from carbonic acid, radicals of the formula CO—SH, —CS—OH, —CS—SH, —CO—NH₂, —CS—NH₂, —C(═NH)—OH or —C(═NH)—NH₂;

also suitable are radicals with hydrocarbon radicals or substituted hydrocarbon radicals, i.e., acyl radicals in the wider sense (i.e., “acyl”).

The safeners are preferably selected from the group consisting of:
S1) compounds of the formula (S1)

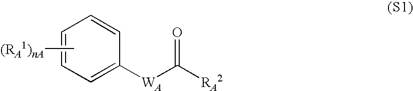

where the symbols and indices have the following meanings:
n_{A} is a natural number from 0 to 5, preferably from 0 to 3;
R_{A}¹ is halogen, (C₁-C₄)-alkyl, (C₁-C₄)-alkoxy, nitro or (C₁-C₄)-haloalkyl;
W_{A} is an unsubstituted or substituted divalent heterocyclic radical from the group consisting of partially unsaturated or aromatic five-membered heterocycles having 1 to 3 hetero ring atoms from the group consisting of N and O, where at least one nitrogen atom and at most one oxygen atom is present in the ring, preferably a radical from the group consisting of (W_{A}¹) to (W_{A}⁴),

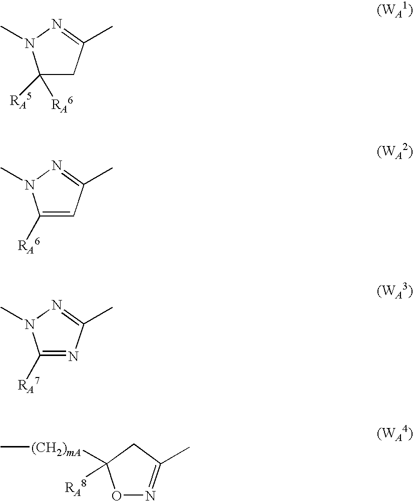

m_{A} is 0 or 1;
R_{A}² is OR_{A}³, SR_{A}³ or NR_{A}³R_{A}⁴ or a saturated or unsaturated 3- to 7-membered heterocycle having at least one nitrogen atom and up to 3 heteroatoms, preferably from the group consisting of O and S, which is attached via the nitrogen atom to the carbonyl group in (S1) and which is unsubstituted or substituted by radicals from the group consisting of (C₁-C₄)-alkyl, (C₁-C₄)-alkoxy and optionally substituted phenyl, preferably a radical of the formula OR_{A}³, NHR_{A}⁴ or N(CH₃)₂, in particular of the formula OR_{A}³;
R_{A}³ is hydrogen or an unsubstituted or substituted aliphatic hydrocarbon radical having preferably a total of 1 to 18 carbon atoms;
R_{A}⁴ is hydrogen, (C₁-C₆)-alkyl, (C₁-C₆)-alkoxy or substituted or unsubstituted phenyl;
R_{A}⁵ is H, (C₁-C₈)-alkyl, (C₁-C₈)-haloalkyl, (C₁-C₄)-alkoxy-(C₁-C₈)-alkyl, cyano or COOR_{A}⁹ where R_{A}⁹ is hydrogen, (C₁-C₈)-alkyl, (C₁-C₈)-haloalkyl, (C₁-C₄)-alkoxy-(C₁-C₄)-alkyl, (C₁-C₆)-hydroxyalkyl, (C₃-C₁₂)-cycloalkyl or tri-(C₁-C₄)-alkylsilyl;
R_{A}⁶, R_{A}⁷, R_{A}⁸ are identical or different and are hydrogen, (C₁-C₈)-alkyl, (C₁-C₈)-haloalkyl, (C₃-C₁₂)-cycloalkyl or substituted or unsubstituted phenyl;
   preferably:
a) compounds of the type of the dichlorophenylpyrazoline-3-carboxylic acid (S1^{a}), preferably compounds such as 1-(2,4-dichlorophenyl)-5-(ethoxy-carbonyl)-5-methyl-2-pyrazoline-3-carboxylic acid, ethyl 1-(2,4-dichloro-phenyl)-5-(ethoxycarbonyl)-5-methyl-2-pyrazoline-3-carboxylate (S1-1) (“mefenpyr(-diethyl)”), and related compounds, as described in WO 91/07874;
b) derivatives of dichlorophenylpyrazolecarboxylic acid (S1^{b}), preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4) and related compounds, as described in EP-A-333 131 and EP-A-269 806;
c) derivatives of 1,5-diphenylpyrazole-3-carboxylic acid (S1^{c}), preferably compounds such as ethyl 1-(2,4-dichlorophenyl)-5-phenylpyrazole-3-carboxylate (S1-5), methyl 1-(2-chlorophenyl)-5-phenylpyrazole-3-carboxylate (S1-6) and related compounds, as described, for example, in EP-A-268554;
d) compounds of the type of the triazolecarboxylic acids (S1^{d}), preferably compounds such as fenchlorazole(-ethyl), i.e. ethyl 1-(2,4-dichlorophenyl)-5-trichloromethyl-(1H)-1,2,4-triazole-3-carboxylate (S1-7), and related compounds, as described in EP-A-174 562 and EP-A-346 620;
e) compounds of the type of the 5-benzyl- or 5-phenyl-2-isoxazoline-3-carboxylic acid or the 5,5-diphenyl-2-isoxazoline-3-carboxylic acid (S1^{e}), preferably compounds such as ethyl 5-(2,4-dichlorobenzyl)-2-isoxazoline-3-carboxylate (S1-8) or ethyl 5-phenyl-2-isoxazoline-3-carboxylate (S1-9) and related compounds, as described in WO-A-91/08202, or 5,5-diphenyl-2-isoxazolinecarboxylic acid (S1-10) or ethyl 5,5-diphenyl-2-isoxazolinecarboxylate (S1-11) (“isoxadifen-ethyl”) or n-propyl 5,5-diphenyl-2-isoxazolinecarboxylate (S1-12) or ethyl 5-(4-fluorophenyl)-5-phenyl-2-isoxazoline-3-carboxylate (S1-13), as described in the patent application WO-A-95/07897.
S2) Quinoline derivatives of the formula (S2),

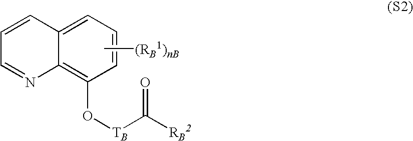

where the symbols and indices have the following meanings:
R_{B}¹ is halogen, (C₁-C₄)-alkyl, (C₁-C₄)-alkoxy, nitro or (C₁-C₄)-haloalkyl;
n_{B} is a natural number from 0 to 5, preferably from 0 to 3;
R_{B}² is OR_{B}³, SR_{B}³ or NR_{B}³R_{B}⁴ or a saturated or unsaturated 3- to 7-membered heterocycle having at least one nitrogen atom and up to 3 heteroatoms, preferably from the group consisting of O and S, which is attached via the nitrogen atom to the carbonyl group in (S2) and which is unsubstituted or substituted by radicals from the group consisting of (C₁-C₄)-alkyl, (C₁-C₄)-alkoxy and optionally substituted phenyl, preferably a radical of the formula OR_{B}³, NHR_{B}⁴ or N(CH₃)₂, in particular of the formula OR_{B}³;
R_{B}³ is hydrogen or an unsubstituted or substituted aliphatic hydrocarbon radical having preferably a total of 1 to 18 carbon atoms;
R_{B}⁴ is hydrogen, (C₁-C₆)-alkyl, (C₁-C₆)-alkoxy or substituted or unsubstituted phenyl;
T_{B} is a (C₁- or C₂)-alkanediyl chain which is unsubstituted or substituted by one or two (C₁-C₄)-alkyl radicals or by [(C₁-C₃)-alkoxy]carbonyl;
   preferably:
a) compounds of the type of the 8-quinolinoxyacetic acid (S2^{a}), preferably 1-methylhexyl (5-chloro-8-quinolinoxy)acetate (common name “cloquintocet-mexyl” (S2-1), 1,3-dimethyl-but-1-yl (5-chloro-8-quinolinoxy)acetate (S2-2), 4-allyloxybutyl (5-chloro-8-quinolinoxy)acetate (S2-3), 1-allyloxyprop-2-yl (5-chloro-8-quinolinoxy)acetate (S2-4), ethyl (5-chloro-8-quinolinoxy)acetate (S2-5), methyl (5-chloro-8-quinolinoxy)acetate (S2-6), allyl (5-chloro-8-quinolinoxy)acetate (S2-7), 2-(2-propylideneiminoxy)-1-ethyl (5-chloro-8-quinolinoxy)acetate (S2-8), 2-oxo-prop-1-yl (5-chloro-8-quinolinoxy)acetate (S2-9) and related compounds, as described in EP-A-86 750, EP-A-94 349 and EP-A-191 736 or EP-A-0 492 366, and also (5-chloro-8-chinolinoxy)acetic acid (S2-10), its hydrates and salts, for example its lithium, sodium, potassium, calcium, magnesium, aluminum, iron, ammonium, quaternary ammonium, sulfonium or phosphonium salts, as described in WO-A-2002/34048;
b) compounds of the type of the (5-chloro-8-quinolinoxy)malonic acid (S2^{b}), preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.
S3) Compounds of the formula (S3)

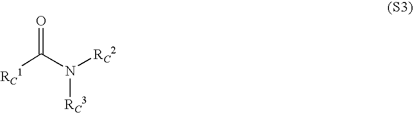

where the symbols and indices have the following meanings:
R_{C}¹ is (C₁-C₄)-alkyl, (C₁-C₄)-haloalkyl, (C₂-C₄)-alkenyl, (C₂-C₄)-haloalkenyl, (C₃-C₇)-cycloalkyl, preferably dichloromethyl;

R_{C}², R_{C}³ are identical or different and are hydrogen, (C₁-C₄)-alkyl, (C₂-C₄)-alkenyl, (C₂-C₄)-alkynyl, (C₁-C₄)-haloalkyl, (C₂-C₄)-haloalkenyl, (C₁-C₄)-alkylcarbamoyl-(C₁-C₄)-alkyl, (C₂-C₄)-alkenylcarbamoyl-(C₁-C₄)-alkyl, (C₁-C₄)-alkoxy-(C₁-C₄)-alkyl, dioxolanyl-(C₁-C₄)-alkyl, thiazolyl, furyl, furylalkyl, thienyl, piperidyl, substituted or unsubstituted phenyl, or R_{C}² and R_{C}³ together form a substituted or unsubstituted heterocyclic ring, preferably an oxazolidine, thiazolidine, piperidine, morpholine, hexahydropyrimidine or benzoxazine ring;

preferably:
active compounds of the type of the dichloroacetamides which are frequently used as pre-emergence safeners (soil-acting safeners), such as, for example,
“dichlormid” (N,N-diallyl-2,2-dichloroacetamide) (S3-1),
“R-29148” (3-dichloroacetyl-2,2,5-trimethyl-1,3-oxazolidine) from Stauffer (S3-2),
“R-28725” (3-dichloroacetyl-2,2-dimethyl-1,3-oxazolidine) from Stauffer (S3-3),
“benoxacor” (4-dichloroacetyl-3,4-dihydro-3-methyl-2H-1,4-benzoxazine) (S3-4),
“PPG-1292” (N-allyl-N-[(1,3-dioxolan-2-yl)methyl]dichloroacetamide) from PPG Industries (S3-5),
“DKA-24” (N-allyl-N-[(allylaminocarbonyl)methyl]dichloroacetamide) from Sagro-Chem (S3-6),
“AD-67” or “MON 4660” (3-dichloroacetyl-1-oxa-3-aza-spiro[4,5]decane) from Nitrokemia or Monsanto (S3-7),
“TI-35” (1-dichloroacetylazepane) from TRI-Chemical RT (S3-8)
“diclonon” (dicyclonone) or “BAS145138” or “LAB145138” (S3-9) ((RS)-1-dichloroacetyl-3,3,8a-trimethylperhydropyrrolo[1,2-a]pyrimidin-6-one) from BASF,
“furilazole” or “MON 13900” ((RS)-3-dichloroacetyl-5-(2-furyl)-2,2-dimethyloxazolidine) (S3-10) and also its (R)-isomer (S3-11).
S4) N-Acylsulfonamides of the formula (S4) and their salts,

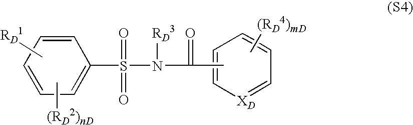

where the symbols and indices have the following meanings:
X_{D is CH or N;}

R_{D}¹ is CO—NR_{D}⁵R_{D}⁶ or NHCO—R_{D}⁷;
R_{D}² is halogen, (C₁-C₄)-haloalkyl, (C₁-C₄)-haloalkoxy, nitro, (C₁-C₄)-alkyl, (C₁-C₄)-alkoxy, (C₁-C₄)-alkylsulfonyl, (C₁-C₄)-alkoxycarbonyl or (C₁-C₄)-alkylcarbonyl;
R_{D}³ is hydrogen, (C₁-C₄)-alkyl, (C₂-C₄)-alkenyl or (C₂-C₄)-alkynyl;
R_{D}⁴ is halogen, nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkylsulfinyl, (C₁-C₄)-alkylsulfonyl, (C₁-C₄)-alkoxycarbonyl or (C₁-C₄)-alkylcarbonyl;
R_{D}⁵ is hydrogen, (C₁-C₆)-alkyl, (C₃-C₆)-cycloalkyl, (C₂-C₆)-alkenyl, (C₂-C₆)-alkynyl, (C₅-C₆)-cycloalkenyl, phenyl or 3- to 6-membered heterocyclyl which contains v_{D} heteroatoms from the group consisting of nitrogen, oxygen and sulfur, where the seven last-mentioned radicals are substituted by v_{D} substituents from the group consisting of halogen, (C₁-C₆)-alkoxy, (C₁-C₆)-haloalkoxy, (C₁-C₂)-alkylsulfinyl, (C₁-C₂)-alkylsulfonyl, (C₃-C₆)-cycloalkyl, (C₁-C₄)-alkoxycarbonyl, (C₁-C₄)-alkylcarbonyl and phenyl and, in the case of cyclic radicals, also (C₁-C₄)-alkyl and (C₁-C₄)-haloalkyl;
R_{D}⁶ is hydrogen, (C₁-C₆)-alkyl, (C₂-C₆)-alkenyl or (C₂-C₆)-alkynyl, where the three last-mentioned radicals are substituted by v_{D} radicals from the group consisting of halogen, hydroxy, (C₁-C₄)-alkyl, (C₁-C₄)-alkoxy and (C₁-C₄)-alkylthio, or
R_{D}⁵ and R_{D}⁶ together with the nitrogen atom carrying them form a pyrrolidinyl or piperidinyl radical;
R_{D}⁷ is hydrogen, (C₁-C₄)-alkylamino, di-(C₁-C₄)-alkylamino, (C₁-C₆)-alkyl, (C₃-C₆)-cycloalkyl, where the 2 last-mentioned radicals are substituted by v_{D} substituents from the group consisting of halogen, (C₁-C₄)-alkoxy, halo-(C₁-C₆)-alkoxy and (C₁-C₄)-alkylthio and, in the case of cyclic radicals, also (C₁-C₄)-alkyl and (C₁-C₄)-haloalkyl;
n_{D} is 0, 1 or 2;
m_{D} is 1 or 2;
v_{D} is 0, 1, 2 or 3;
   from among these, preference is given to compounds of the type of the N-acylsulfonamides, for example of the formula (S4^{a}) below, which are known, for example, from WO-A-97/45016

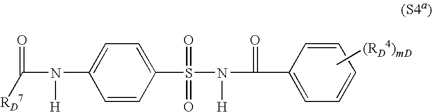

in which
R_{D}⁷ is (C₁-C₆)-alkyl, (C₃-C₆)-cycloalkyl, where the 2 last-mentioned radicals are substituted by v_{D} substituents from the group consisting of halo, (C₁-C₄)-alkoxy, halo-(C₁-C₆)-alkoxy and (C₁-C₄)-alkylthio and, in the case of cyclic radicals, also (C₁-C₄)-alkyl and (C₁-C₄)-haloalkyl;
R_{D}⁴ is halogen, (C₁-C₄)-alkyl, (C₁-C₄)-alkoxy, CF₃,
m_{D} 1 or 2;
v_{D} is 0, 1, 2 or 3;
   and also
   acylsulfamoylbenzamides, for example of the formula (S4^{b}) below, which are known, for example, from WO-A-99/16744,

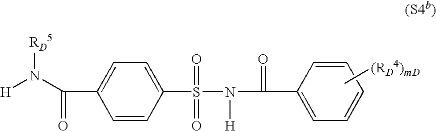

for example those in which
R_{D}⁵=cyclopropyl and (R_{D}⁴)=2-OMe (“cyprosulfamide”, S4-1),
R_{D}⁵=cyclopropyl and (R_{D}⁴)=5-Cl-2-OMe (S4-2),
R_{D}⁵=ethyl and (R_{D}⁴)=2-OMe (S4-3),
R_{D}⁵=isopropyl and (R_{D}⁴)=5-Cl-2-OMe (S4-4) and
R_{D}⁵=isopropyl and (R_{D}⁴)=2-OMe (S4-5)
and also
compounds of the type of the N-acylsulfamoylphenylureas of the formula (S4^{C}), which are known, for example, from EP-A-365484,

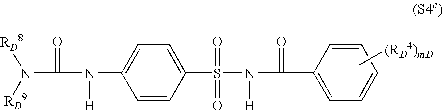

in which
R_{D}⁸ and R_{D}⁹ independently of one another are hydrogen, (C₁-C₈)-alkyl, (C₃-C₈)-cycloalkyl, (C₃-C₆)-alkenyl, (C₃-C₆)-alkynyl,
R_{D}⁴ is halogen, (C₁-C₄)-alkyl, (C₁-C₄)-alkoxy, CF₃,
m_{D} is 1 or 2;
   for example
1-[4-(N-2-methoxybenzoylsulfamoyl)phenyl]-3-methylurea,
1-[4-(N-2-methoxybenzoylsulfamoyl)phenyl]-3,3-dimethylurea,
1-[4-(N-4,5-dimethylbenzoylsulfamoyl)phenyl]-3-methylurea.
S5) Active compounds from the class of the hydroxyaromatics and aromatic-aliphatic carboxylic acid derivatives (S5), for example
   ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicyclic acid, 2-hydroxycinnamic acid, 2,4-dichlorocinnamic acid, as described in WO-A-2004/084631, WO-A-2005/015994, WO-A-2005/016001.
S6) Active compounds from the class of the 1,2-dihydroquinoxalin-2-ones (S6), for example
   1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulfonylaminoethyl)-3-(2-thienyl)-1,2-dihydroquinoxalin-2-one, as described in WO-A-2005/112630.
S7) Compounds of the formula (S7), as described in WO-A-1998/38856,

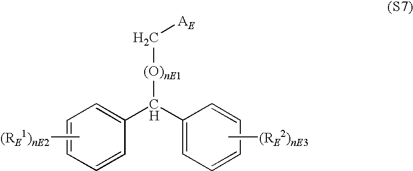

where the symbols and indices have the following meanings:
R_{E}¹, R_{E}² independently of one another are halogen, (C₁-C₄)-alkyl, (C₁-C₄)-alkoxy, (C₁-C₄)-haloalkyl, (C₁-C₄)-alkylamino, di-(C₁-C₄)-alkylamino, nitro;
A_{E} is COOR_{E}³ or COSR_{E}⁴
R_{E}³, R_{E}⁴ independently of one another are hydrogen, (C₁-C₄)-alkyl, (C₂-C₆)-alkenyl, (C₂-C₄)-alkynyl, cyanoalkyl, (C₁-C₄)-haloalkyl, phenyl, nitrophenyl, benzyl, halobenzyl, pyridinylalkyl or alkylammonium,
n_{E}¹ is 0 or 1;
n_{E}², n_{E}³ independently of one another are 0, 1 or 2,
   preferably:
   diphenylmethoxyacetic acid,
   ethyl diphenylmethoxyacetate,
   methyl diphenylmethoxyacetate (CAS Reg. No.: 41858-19-9) (S7-1).
S8) Compounds of the formula (S8), as described in WO-A-98/27049

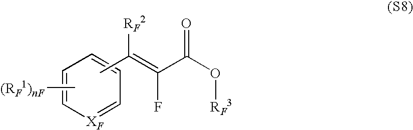

in which
X_{F} is CH or N,
n_{F} is, if X_{F}═N, an integer from 0 to 4 and
   is, if X_{F}═CH, an integer from 0 to 5,
R_{F}¹ is halogen, (C₁-C₄)-alkyl, (C₁-C₄)-haloalkyl, (C₁-C₄)-alkoxy, (C₁-C₄)-haloalkoxy, nitro, (C₁-C₄)-alkylthio, (C₁-C₄)-alkylsulfonyl, (C₁-C₄)-alkoxycarbonyl, optionally substituted phenyl, optionally substituted phenoxy,
R_{F}² is hydrogen or (C₁-C₄)-alkyl,
R_{F}³ is hydrogen, (C₁-C₈)-alkyl, (C₂-C₄)-alkenyl, (C₂-C₄)-alkynyl or aryl, where each of the carbon-containing radicals mentioned above is unsubstituted or substituted by one or more, preferably by up to three, identical or different radicals from the group consisting of halogen and alkoxy; or salts thereof,
   preferably compounds in which
X_{F} is CH,
n_{F} is an integer from 0 to 2,
R_{F}¹ is halogen, (C₁-C₄)-alkyl, (C₁-C₄)-haloalkyl, (C₁-C₄)-alkoxy, (C₁-C₄)-haloalkoxy,
R_{F}² is hydrogen or (C₁-C₄)-alkyl,
R_{F}³ is hydrogen, (C₁-C₈)-alkyl, (C₂-C₄)-alkenyl, (C₂-C₄)-alkynyl or aryl, where each of the carbon-containing radicals mentioned above is unsubstituted or substituted by one or more, preferably by up to three, identical or different radicals from the group consisting of halogen and alkoxy; or salts thereof,
S9) Active compounds from the class of the 3-(5-tetrazolylcarbonyl)-2-quinolones (S9), for example
   1,2-dihydro-4-hydroxy-1-ethyl-3-(5-tetrazolylcarbonyl)-2-quinolone (CAS Reg. No.: 219479-18-2), 1,2-dihydro-4-hydroxy-1-methyl-3-(5-tetrazolylcarbonyl)-2-quinolone (CAS Reg. No.: 95855-00-8) (S9-1), as described in WO-A-1999/000020.
S10) Compounds of the formula (S10^{a}) or (S10^{b})
   as described in WO-A-2007/023719 and WO-A-2007/023764

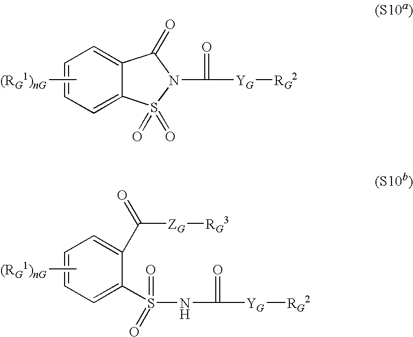

in which
R_{G}¹ is halogen, (C₁-C₄)-alkyl, methoxy, nitro, cyano, CF₃, OCF₃
Y_{G}, Z_{G} independently of one another are O or S,
n_{G} is an integer from 0 to 4,
R_{G}² is (C₁-C₁₆)-alkyl, (C₂-C₆)-alkenyl, (C₃-C₆)-cycloalkyl, aryl; benzyl, halobenzyl,
R_{G}³ is hydrogen or (C₁-C₆)-alkyl.
S11) Active compounds of the type of the oxyimino compounds (S11), which are known as seed dressings, such as, for example,
   “oxabetrinil” ((Z)-1,3-dioxolan-2-ylmethoxyimino(phenyl)acetonitrile) (S11-1), which is known as seed dressing safener for millet against metolachlor damage,
   “fluxofenim” (1-(4-chlorophenyl)-2,2,2-trifluoro-1-ethanone O-(1,3-dioxolan-2-ylmethyl)oxime) (S11-2), which is known as seed dressing safener for millet against metolachlor damage, and
   “cyometrinil” or “CGA-43089” ((Z)-cyanomethoxyimino(phenyl)acetonitrile) (S11-3), which is known as seed dressing safener for millet against metolachlor damage.
S12) Active compounds from the class of the isothiochromanones (S12), such as, for example, methyl [(3-oxo-1H-2-benzothiopyran-4(3H)-ylidene)methoxy]acetate (CAS Reg. No.: 205121-04-6) (S12-1) and related compounds from WO-A-1998/13361.
S13) One or more compounds from group (S13):
   “naphthalic anhydrid” (1,8-naphthalenedicarboxylic anhydride) (S13-1), which is known as seed dressing safener for corn against thiocarbamate herbicide damage,
   “fenclorim” (4,6-dichloro-2-phenylpyrimidine) (S13-2), which is known as safener for pretilachlor in sown rice,
   “flurazole” (benzyl 2-chloro-4-trifluoromethyl-1,3-thiazole-5-carboxylate) (S13-3), which is known as seed dressing safener for millet against alachlor and metolachlor damage,
   “CL-304415” (CAS Reg. No.: 31541-57-8) (4-carboxy-3,4-dihydro-2H-1-benzopyran-4-acetic acid) (S13-4) from American Cyanamid, which is known as safener for corn against imidazolinone damage,
   “MG-191” (CAS Reg. No.: 96420-72-3) (2-dichloromethyl-2-methyl-1,3-dioxolane) (S13-5) from Nitrokemia, which is known as safener for corn,
   “MG-838” (CAS Reg. No.: 133993-74-5) (2-propenyl 1-oxa-4-azaspiro[4.5]decane-4-carbodithioate) (S13-6) from Nitrokemia,
   “disulfoton” (O,O-diethyl S-2-ethylthioethyl phosphorodithioate) (S13-7),
   “dietholate” (O,O-diethyl O-phenyl phosphorothioate) (S13-8),
   “mephenate” (4-chlorophenyl methylcarbamate) (S13-9).

Compounds which are preferred as component (B) are, including possible stereoisomers and agriculturally customary esters or salts: (S1-1) mefenpyr(-diethyl), (S1-7) fenchlorazole(-ethyl), (S1-12) isoxadifen(-ethyl), (S2-1) cloquintocet(-mexyl), (S3-1) dichlormid, (S3-2) R-29148 (3-dichloroacetyl-2,2,5-trimethyl-1,3-oxazolidine), (S3-3) R-28725 (3-dichloroacetyl-2,2-dimethyl-1,3-oxazolidine), (S3-4) benoxacor, (S3-5) PPG-1292 (N-allyl-N-[(1,3-dioxolan-2-yl)-methyl]dichloroacetamide), (S3-6) DKA-24 (N-allyl-N-[(allylaminocarbonyl)methyl]-dichloroacetamide), (S3-7) AD-67/MON 4660 (3-dichloroacetyl-1-oxa-3-aza-spiro[4,5]decane), (S3-8) TI-35 (1-dichloroacetylazepane), (S3-9) dicyclonon, (S3-10)/(S3-11) furilazole, (S4-1) cyprosulfamide, (S7-1) methyl (diphenylmethoxy)acetate (CAS Reg. No.: 41858-19-9), (S9-1) 1,2-dihydro-4-hydroxy-1-methyl-3-(5-tetrazolylcarbonyl)-2-quinolone (CAS Reg. No.: 95855-00-8), (S11-1) oxabetrinil, (S11-2) fluxofenim, (S11-3) cyometrinil, (S12-1) methyl [(3-oxo-1H-2-benzothiopyran-4(3H)-ylidene)methoxy]acetate (CAS Reg. No.: 205121-04-6), (S13-1) naphthalic anhydride, (S13-2) fenclorim, (S13-3) flurazole, (S13-4) CL-304415 (4-carboxy-3,4-d ihydro-2H-1-benzopyran-4-acetic acid), (S13-5) MG-191 (2-dichloromethyl-2-methyl-1,3-dioxolane), (S13-6) MG-838 (2-propenyl 1-oxa-4-azaspiro[4.5]decane-4-carbodithioate), (S13-7) disulfoton (O,O-diethyl S-2-ethylthioethyl phosphorodithioate), (S13-8) dietholate, (S13-9) mephenate; particularly preferably (S1-1) mefenpyr(-diethyl), (S1-7) fenchlorazole(-ethyl), (S1-12) isoxadifen(-ethyl), (S2-1) cloquintocet (-mexyl), (S3-1) dichlormid, (S3-4) benoxacor, (S3-7) AD-67/MON 4660 (3-dichloroacetyl-1-oxa-3-azaspiro[4,5]decane), (S3-8) TI-35 (1-dichloroacetylazepane), (S3-10)/(S3-11) furilazole, (S4-1) cyprosulfamide, (S11-1) oxabetrinil, (S11-2) fluxofenim, (S11-3) cyometrinil, (S13-1) naphthalic anhydride, (S13-2) fenclorim, (S13-3) flurazole; very particularly preferably (S1-1) mefenpyr(-diethyl), (S1-7) fenchlorazole(-ethyl), (S1-12) isoxadifen(-ethyl), (S2-1) cloquintocet (-mexyl), (S3-1) dichlormid, (S3-4) benoxacor, (S3-7) AD-67/MON 4660 (3-dichloroacetyl-1-oxa-3-azaspiro[4,5]decane), (S3-10)/(S3-11) furilazole, (S4-1) cyprosulfamide, (S11-2) fluxofenim, (S13-2) fenclorim, (S13-3) flurazole.

Particularly preferred combinations of herbicides (A) and safeners (B) are those in which the safener (B) is selected from the group of safeners consisting of the compounds (S1-1) mefenpyr(-diethyl), (S1-12) isoxadifen(-ethyl), (S2-1) cloquintocet (-mexyl), (S4-1) cyprosulfamide; very particularly preferred as safeners (B) are (S1-1) mefenpyr(-diethyl), (S1-12) isoxadifen(-ethyl) and (S4-1) cyprosulfamide.

Particularly preferred for use in rice are (S1-12) isoxadifen(-ethyl) and (S13-2) fenclorim. Particularly preferred for use in cereals are (S1-1) mefenpyr(-diethyl), (S2-1) cloquintocet (-mexyl), (S4-1) cyprosulfamide, in corn in particular (S1-12) isoxadifen(-ethyl) and (S4-1) cyprosulfamide. For use in sugar cane, preference is given to (S1-12) isoxadifen(-ethyl) and (S4-1) cyprosulfamide.

The safeners (group B compounds) of the formulae (S-1) to (S-13) are suitable for reducing phytotoxic effects which may occur when herbicides (A) are used in crops of useful plants, while having no major adverse effect on the activity of these herbicidal active compounds against harmful plants. By virtue of these properties, it is possible to extend the field of application of customary crop protection compositions considerably, for example to crops in which it has hitherto not been possible to employ the herbicides at all or to employ them only to a limited extent.

Depending on indication and herbicidal active compound used, the required application rates of the safeners can vary within wide limits and are generally in the range from 1 to 5000 g, preferably from 2 to 4000 g, in particular from 3 to 2500 g of active compound per hectare.

In a preferred embodiment, the herbicide/safener combinations according to the invention comprise effective amounts of the herbicides (A) and the safeners (B). The actions can be observed, for example, when applying the herbicides (A) and safeners (B) together, for example as a coformulation or as a tank mix; however, they can also be observed when the active compounds are applied at different times (splitting). It is also possible to apply the herbicides or safeners or the herbicide/safener combinations in a plurality of portions (sequential application), for example applications as seed treatment or pre-seed (plant) treatment or in pre-emergence applications followed by post-emergence applications or early post-emergence applications followed by medium or late post-emergence applications. Preference is given here to the joint or almost simultaneous application of the herbicides (A) and safeners (B) of the combination in question, and the joint application is particularly preferred.

The weight ratio of herbicide (A): safener (B) may vary within wide limits and is preferably in the range from 1:50000 to 500:1, in particular from 1:8000 to 250:1, very particularly preferably from 1:2500 to 50:1. The optimum amounts of herbicide and safener depend in each case on the type of herbicide used and the type of safener used and on the nature and the development stage of the plant stock to be treated and can be determined in each individual case by simple routine preliminary experiments.

Depending on their properties, the safeners (B) contained in the herbicide/safener combination according to the invention can be used for pretreating the seed of the crop plant (for example for seed dressing) or introduced into the seed furrows prior to sowing or used together with the herbicide before or after emergence of the plants. Pre-emergence treatment includes not only the treatment of the area under cultivation (including, if appropriate, water present on the area under cultivation, for example in the case of rice applications) before sowing/planting out, but also the treatment of the sown soil which does not yet sustain vegetation. Preferred is the application together with the herbicide. Tank mixes or ready mixes may be employed for this purpose.

In a preferred embodiment, the seed (for example grains, seed or vegetative propagation organs, such as tubers or shoot parts with buds) or seedlings are pretreated with the safeners (B), if appropriate in combination with other agrochemically active compounds For pretreating the seed, the active compounds can be applied to the seed, for example, by dressing, or the active compounds and the seed can be introduced into water or other solvents, and the active compounds can be taken up, for example, by adduct formation or diffusion in a dip process or by swelling or pregermination. For the pretreatment of seedlings, the young plants can be brought into contact with the safeners, if appropriate in combination with other agrochemically active compounds, for example by spraying, dipping or watering, and then be transplanted and, if appropriate, be subjected to a post-treatment with the herbicides (A).

The treatment of the seed or the seedlings can be carried out using the safeners (B) alone or together with other agrochemically active compounds, such as fungicides, insecticides or agents for fortifying the plant, for fertilizing or for promoting the swelling and germination processes. Here, the safeners may, after the pretreatment application, be applied once more before, after or together with one or more herbicides (A) optionally also in combination with other known herbicides. By pretreating the seed or the seedlings, it is possible to achieve better long-term action of the safeners.

Preference is given to herbicide/safener combinations of one or more herbicides (A) and one or more safeners (B). Here, combinations additionally comprising one or more further agrochemically active compounds which differ from the herbicides (A) and safeners (B) but also act as selective herbicides are likewise in accordance with the invention.

For combinations of three or more active compounds, the preferred conditions illustrated below in particular for two-component combinations according to the invention primarily also apply, provided they comprise the two-component combinations according to the invention.

Of particular interest is the use of herbicide/safener combinations having a content of the following compounds (A)+(B): (A-1)+(S1), (A-1)+(S1^{a}), (A-1)+(S1^{b}), (A-1)+(S1^{c}), (A-1)+(S1^{d}), (A-1)+(S1^{e}), (A-1)+(S1-1), (A-1)+(S1-2), (A-1)+(S1-3), (A-1)+(S1-4), (A-1)+(S1-5), (A-1)+(S1-6), (A-1)+(S1-7), (A-1)+(S1-8), (A-1)+(S1-9), (A-1)+(S1-10), (A-1)+(S1-11), (A-1)+(S1-12), (A-1)+(S1-13), (A-1)+(S2), (A-1)+(S2^{a}), (A-1)+(S2^{b}), (A-1)+(S2-1), (A-1)+(S2-2), (A-1)+(S2-3), (A-1)+(S2-4), (A-1)+(S2-5), (A-1)+(S2-6), (A-1)+(S2-7), (A-1)+(S2-8), (A-1)+(S2-9), (A-1)+(S2-10), (A-1)+(S3), (A-1)+(S3-1), (A-1)+(S3-2), (A-1)+(S3-3), (A-1)+(S3-4), (A-1)+(S3-5), (A-1)+(S3-6), (A-1)+(S3-7), (A-1)+(S3-8), (A-1)+(S3-9), (A-1)+(S3-10), (A-1)+(S3-11), (A-1)+(S4), (A-1)+(S4^{a}), (A-1)+(S4^{b}), (A-1)+(S4^{c}), (A-1)+(S4-1), (A-1)+(S4-2), (A-1)+(S4-3), (A-1)+(S4-4), (A-1)+(S4-5), (A-1)+(S5), (A-1)+(S6), (A-1)+(S7), (A-1)+(S7-1), (A-1)+(S8), (A-1)+(S9), (A-1)+(S9-1), (A-1)+(S10), (A-1)+(S10^{a}), (A-1)+(S10^{b}), (A-1)+(S11), (A-1)+(S11-1), (A-1)+(S11-2), (A-1)+(S11-3), (A-1)+(S12), (A-1)+(S12-1), (A-1)+(S13), (A-1)+(S13-1), (A-1)+(S13-2), (A-1)+(S13-3), (A-1)+(S13-4), (A-1)+(S13-5), (A-1)+(S13-6), (A-1)+(S13-7), (A-1)+(S13-8), (A-1)+(S13-9);

(A-2)+(S1), (A-2)+(S1^{a}), (A-2)+(S1^{b}), (A-2)+(S1^{c}), (A-2)+(S1^{d}), (A-2)+(S1^{e}), (A-2)+(S1-1), (A-2)+(S1-2), (A-2)+(S1-3), (A-2)+(S1-4), (A-2)+(S1-5), (A-2)+(S1-6), (A-2)+(S1-7), (A-2)+(S1-8), (A-2)+(S1-9), (A-2)+(S1-10), (A-2)+(S1-11), (A-2)+(S1-12), (A-2)+(S1-13), (A-2)+(S2), (A-2)+(S2^{a}), (A-2)+(S2^{b}), (A-2)+(S2-1), (A-2)+(S2-2), (A-2)+(S2-3), (A-2)+(S2-4), (A-2)+(S2-5), (A-2)+(S2-6), (A-2)+(S2-7), (A-2)+(S2-8), (A-2)+(S2-9), (A-2)+(S2-10), (A-2)+(S3), (A-2)+(S3-1), (A-2)+(S3-2), (A-2)+(S3-3), (A-2)+(S3-4), (A-2)+(S3-5), (A-2)+(S3-6), (A-2)+(S3-7), (A-2)+(S3-8), (A-2)+(S3-9), (A-2)+(S3-10), (A-2)+(S3-11), (A-2)+(S4), (A-2)+(S4^{a}), (A-2)+(S4^{b}), (A-2)+(S4^{c}), (A-2)+(S4-1), (A-2)+(S4-2), (A-2)+(S4-3), (A-2)+(S4-4), (A-2)+(S4-5), (A-2)+(S5), (A-2)+(S6), (A-2)+(S7), (A-2)+(S7-1), (A-2)+(S8), (A-2)+(S9), (A-2)+(S9-1), (A-2)+(S10), (A-2)+(S10^{a}), (A-2)+(S10^{b}), (A-2)+(S11), (A-2)+(S11-1), (A-2)+(S11-2), (A-2)+(S11-3), (A-2)+(S12), (A-2)+(S12-1), (A-2)+(S13), (A-2)+(S13-1), (A-2)+(S13-2), (A-2)+(S13-3), (A-2)+(S13-4), (A-2)+(S13-5), (A-2)+(S13-6), (A-2)+(S13-7), (A-2)+(S13-8), (A-2)+(S13-9);
(A-3)+(S1), (A-3)+(S1^{a}), (A-3)+(S1^{b}), (A-3)+(S1^{c}), (A-3)+(S1^{d}), (A-3)+(S1^{e}), (A-3)+(S1-1), (A-3)+(S1-2), (A-3)+(S1-3), (A-3)+(S1-4), (A-3)+(S1-5), (A-3)+(S1-6), (A-3)+(S1-7), (A-3)+(S1-8), (A-3)+(S1-9), (A-3)+(S1-10), (A-3)+(S1-11), (A-3)+(S1-12), (A-3)+(S1-13), (A-3)+(S2), (A-3)+(S2^{a}), (A-3)+(S2^{b}), (A-3)+(S2-1), (A-3)+(S2-2), (A-3)+(S2-3), (A-3)+(S2-4), (A-3)+(S2-5), (A-3)+(S2-6), (A-3)+(S2-7), (A-3)+(S2-8), (A-3)+(S2-9), (A-3)+(S2-10), (A-3)+(S3), (A-3)+(S3-1), (A-3)+(S3-2), (A-3)+(S3-3), (A-3)+(S3-4), (A-3)+(S3-5), (A-3)+(S3-6), (A-3)+(S3-7), (A-3)+(S3-8), (A-3)+(S3-9), (A-3)+(S3-10), (A-3)+(S3-11), (A-3)+(S4), (A-3)+(S4^{a}), (A-3)+(S4^{b}), (A-3)+(S4^{c}), (A-3)+(S4-1), (A-3)+(S4-2), (A-3)+(S4-3), (A-3)+(S4-4), (A-3)+(S4-5), (A-3)+(S5), (A-3)+(S6), (A-3)+(S7), (A-3)+(S7-1), (A-3)+(S8), (A-3)+(S9), (A-3)+(S9-1), (A-3)+(S10), (A-3)+(S10^{a}), (A-3)+(S10^{b}), (A-3)+(S11), (A-3)+(S11-1), (A-3)+(S11-2), (A-3)+(S11-3), (A-3)+(S12), (A-3)+(S12-1), (A-3)+(S13), (A-3)+(S13-1), (A-3)+(S13-2), (A-3)+(S13-3), (A-3)+(S13-4), (A-3)+(S13-5), (A-3)+(S13-6), (A-3)+(S13-7), (A-3)+(S13-8), (A-3)+(S13-9);
(A-4)+(S1), (A-4)+(S1^{a}), (A-4)+(S1^{b}), (A-4)+(S1^{c}), (A-4)+(S1^{d}), (A-4)+(S1^{e}), (A-4)+(S1-1), (A-4)+(S1-2), (A-4)+(S1-3), (A-4)+(S1-4), (A-4)+(S1-5), (A-4)+(S1-6), (A-4)+(S1-7), (A-4)+(S1-8), (A-4)+(S1-9), (A-4)+(S1-10), (A-4)+(S1-11), (A-4)+(S1-12), (A-4)+(S1-13), (A-4)+(S2), (A-4)+(S2^{a}), (A-4)+(S2^{b}), (A-4)+(S2-1), (A-4)+(S2-2), (A-4)+(S2-3), (A-4)+(S2-4), (A-4)+(S2-5), (A-4)+(S2-6), (A-4)+(S2-7), (A-4)+(S2-8), (A-4)+(S2-9), (A-4)+(S2-10), (A-4)+(S3), (A-4)+(S3-1), (A-4)+(S3-2), (A-4)+(S3-3), (A-4)+(S3-4), (A-4)+(S3-5), (A-4)+(S3-6), (A-4)+(S3-7), (A-4)+(S3-8), (A-4)+(S3-9), (A-4)+(S3-10), (A-4)+(S3-11), (A-4)+(S4), (A-4)+(S4^{a}), (A-4)+(S4^{b}), (A-4)+(S4^{c}), (A-4)+(S4-1), (A-4)+(S4-2), (A-4)+(S4-3), (A-4)+(S4-4), (A-4)+(S4-5), (A-4)+(S5), (A-4)+(S6), (A-4)+(S7), (A-4)+(S7-1), (A-4)+(S8), (A-4)+(S9), (A-4)+(S9-1), (A-4)+(S10), (A-4)+(S10^{a}), (A-4)+(S10^{b}), (A-4)+(S11), (A-4)+(S11-1), (A-4)+(S11-2), (A-4)+(S11-3), (A-4)+(S12), (A-4)+(S12-1), (A-4)+(S13), (A-4)+(S13-1), (A-4)+(S13-2), (A-4)+(S13-3), (A-4)+(S13-4), (A-4)+(S13-5), (A-4)+(S13-6), (A-4)+(S13-7), (A-4)+(S13-8), (A-4)+(S13-9);
(A-5)+(S1), (A-5)+(S1^{a}), (A-5)+(S1^{b}), (A-5)+(S1^{c}), (A-5)+(S1^{d}), (A-5)+(S1^{e}), (A-5)+(S1-1), (A-5)+(S1-2), (A-5)+(S1-3), (A-5)+(S1-4), (A-5)+(S1-5), (A-5)+(S1-6), (A-5)+(S1-7), (A-5)+(S1-8), (A-5)+(S1-9), (A-5)+(S1-10), (A-5)+(S1-11), (A-5)+(S1-12), (A-5)+(S1-13), (A-5)+(S2), (A-5)+(S2^{a}), (A-5)+(S2^{b}), (A-5)+(S2-1), (A-5)+(S2-2), (A-5)+(S2-3), (A-5)+(S2-4), (A-5)+(S2-5), (A-5)+(S2-6), (A-5)+(S2-7), (A-5)+(S2-8), (A-5)+(S2-9), (A-5)+(S2-10), (A-5)+(S3), (A-5)+(S3-1), (A-5)+(S3-2), (A-5)+(S3-3), (A-5)+(S3-4), (A-5)+(S3-5), (A-5)+(S3-6), (A-5)+(S3-7), (A-5)+(S3-8), (A-5)+(S3-9), (A-5)+(S3-10), (A-5)+(S3-11), (A-5)+(S4), (A-5)+(S4^{a}), (A-5)+(S4^{b}), (A-5)+(S4^{c}), (A-5)+(S4-1), (A-5)+(S4-2), (A-5)+(S4-3), (A-5)+(S4-4), (A-5)+(S4-5), (A-5)+(S5), (A-5)+(S6), (A-5)+(S7), (A-5)+(S7-1), (A-5)+(S8), (A-5)+(S9), (A-5)+(S9-1), (A-5)+(S10), (A-5)+(S10^{a}), (A-5)+(S10^{b}), (A-5)+(S11), (A-5)+(S11-1), (A-5)+(S11-2), (A-5)+(S11-3), (A-5)+(S12), (A-5)+(S12-1), (A-5)+(S13), (A-5)+(S13-1), (A-5)+(S13-2), (A-5)+(S13-3), (A-5)+(S13-4), (A-5)+(S13-5), (A-5)+(S13-6), (A-5)+(S13-7), (A-5)+(S13-8), (A-5)+(S13-9);
(A-6)+(S1), (A-6)+(S1^{a}), (A-6)+(S1^{b}), (A-6)+(S1^{c}), (A-6)+(S1^{d}), (A-6)+(S1^{e}), (A-6)+(S1-1), (A-6)+(S1-2), (A-6)+(S1-3), (A-6)+(S1-4), (A-6)+(S1-5), (A-6)+(S1-6), (A-6)+(S1-7), (A-6)+(S1-8), (A-6)+(S1-9), (A-6)+(S1-10), (A-6)+(S1-11), (A-6)+(S1-12), (A-6)+(S1-13), (A-6)+(S2), (A-6)+(S2^{a}), (A-6)+(S2^{b}), (A-6)+(S2-1), (A-6)+(S2-2), (A-6)+(S2-3), (A-6)+(S2-4), (A-6)+(S2-5), (A-6)+(S2-6), (A-6)+(S2-7), (A-6)+(S2-8), (A-6)+(S2-9), (A-6)+(S2-10), (A-6)+(S3), (A-6)+(S3-1), (A-6)+(S3-2), (A-6)+(S3-3), (A-6)+(S3-4), (A-6)+(S3-5), (A-6)+(S3-6), (A-6)+(S3-7), (A-6)+(S3-8), (A-6)+(S3-9), (A-6)+(S3-10), (A-6)+(S3-11), (A-6)+(S4), (A-6)+(S4^{a}), (A-6)+(S4^{b}), (A-6)+(S4^{c}), (A-6)+(S4-1), (A-6)+(S4-2), (A-6)+(S4-3), (A-6)+(S4-4), (A-6)+(S4-5), (A-6)+(S5), (A-6)+(S6), (A-6)+(S7), (A-6)+(S7-1), (A-6)+(S8), (A-6)+(S9), (A-6)+(S9-1), (A-6)+(S10), (A-6)+(S10^{a}), (A-6)+(S10^{b}), (A-6)+(S11), (A-6)+(S11-1), (A-6)+(S11-2), (A-6)+(S11-3), (A-6)+(S12), (A-6)+(S12-1), (A-6)+(S13), (A-6)+(S13-1), (A-6)+(S13-2), (A-6)+(S13-3), (A-6)+(S13-4), (A-6)+(S13-5), (A-6)+(S13-6), (A-6)+(S13-7), (A-6)+(S13-8), (A-6)+(S13-9);
(A-7)+(S1), (A-7)+(S1^{a}), (A-7)+(S1^{b}), (A-7)+(S1^{c}), (A-7)+(S1^{d}), (A-7)+(S1^{e}), (A-7)+(S1-1), (A-7)+(S1-2), (A-7)+(S1-3), (A-7)+(S1-4), (A-7)+(S1-5), (A-7)+(S1-6), (A-7)+(S1-7), (A-7)+(S1-8), (A-7)+(S1-9), (A-7)+(S1-10), (A-7)+(S1-11), (A-7)+(S1-12), (A-7)+(S1-13), (A-7)+(S2), (A-7)+(S2^{a}), (A-7)+(S2^{b}), (A-7)+(S2-1), (A-7)+(S2-2), (A-7)+(S2-3), (A-7)+(S2-4), (A-7)+(S2-5), (A-7)+(S2-6), (A-7)+(S2-7), (A-7)+(S2-8), (A-7)+(S2-9), (A-7)+(S2-10), (A-7)+(S3), (A-7)+(S3-1), (A-7)+(S3-2), (A-7)+(S3-3), (A-7)+(S3-4), (A-7)+(S3-5), (A-7)+(S3-6), (A-7)+(S3-7), (A-7)+(S3-8), (A-7)+(S3-9), (A-7)+(S3-10), (A-7)+(S3-11), (A-7)+(S4), (A-7)+(S4^{a}), (A-7)+(S4^{b}), (A-7)+(S4^{c}), (A-7)+(S4-1), (A-7)+(S4-2), (A-7)+(S4-3), (A-7)+(S4-4), (A-7)+(S4-5), (A-7)+(S5), (A-7)+(S6), (A-7)+(S7), (A-7)+(S7-1), (A-7)+(S8), (A-7)+(S9), (A-7)+(S9-1), (A-7)+(S10), (A-7)+(S10^{a}), (A-7)+(S10^{b}), (A-7)+(S11), (A-7)+(S11-1), (A-7)+(S11-2), (A-7)+(S11-3), (A-7)+(S12), (A-7)+(S12-1), (A-7)+(S13), (A-7)+(S13-1), (A-7)+(S13-2), (A-7)+(S13-3), (A-7)+(S13-4), (A-7)+(S13-5), (A-7)+(S13-6), (A-7)+(S13-7), (A-7)+(S13-8), (A-7)+(S13-9);
(A-8)+(S1), (A-8)+(S1^{a}), (A-8)+(S1^{b}), (A-8)+(S1^{c}), (A-8)+(S1^{d}), (A-8)+(S1^{e}), (A-8)+(S1-1), (A-8)+(S1-2), (A-8)+(S1-3), (A-8)+(S1-4), (A-8)+(S1-5), (A-8)+(S1-6), (A-8)+(S1-7), (A-8)+(S1-8), (A-8)+(S1-9), (A-8)+(S1-10), (A-8)+(S1-11), (A-8)+(S1-12), (A-8)+(S1-13), (A-8)+(S2), (A-8)+(S2^{a}), (A-8)+(S2^{b}), (A-8)+(S2-1), (A-8)+(S2-2), (A-8)+(S2-3), (A-8)+(S2-4), (A-8)+(S2-5), (A-8)+(S2-6), (A-8)+(S2-7), (A-8)+(S2-8), (A-8)+(S2-9), (A-8)+(S2-10), (A-8)+(S3), (A-8)+(S3-1), (A-8)+(S3-2), (A-8)+(S3-3), (A-8)+(S3-4), (A-8)+(S3-5), (A-8)+(S3-6), (A-8)+(S3-7), (A-8)+(S3-8), (A-8)+(S3-9), (A-8)+(S3-10), (A-8)+(S3-11), (A-8)+(S4), (A-8)+(S4^{a}), (A-8)+(S4^{b}), (A-8)+(S4^{c}), (A-8)+(S4-1), (A-8)+(S4-2), (A-8)+(S4-3), (A-8)+(S4-4), (A-8)+(S4-5), (A-8)+(S5), (A-8)+(S6), (A-8)+(S7), (A-8)+(S7-1), (A-8)+(S8), (A-8)+(S9), (A-8)+(S9-1), (A-8)+(S10), (A-8)+(S10^{a}), (A-8)+(S10^{b}), (A-8)+(S11), (A-8)+(S11-1), (A-8)+(S11-2), (A-8)+(S11-3), (A-8)+(S12), (A-8)+(S12-1), (A-8)+(S13), (A-8)+(S13-1), (A-8)+(S13-2), (A-8)+(S13-3), (A-8)+(S13-4), (A-8)+(S13-5), (A-8)+(S13-6), (A-8)+(S13-7), (A-8)+(S13-8), (A-8)+(S13-9).

The herbicide/safener combinations according to the invention may furthermore comprise, as additional further components, various agrochemically active compounds, for example from the group of the fungicides, insecticides, acaricides, nematicides, bird repellants, soil structure improvers, plant nutrients (fertilizers), and herbicides which differ structurally from herbicides (A), and plant growth regulators, or from the group of the formulation auxiliaries and additives customary in crop protection.

Thus, suitable agrochemically active compounds which may be used are further herbicides which differ structurally from the individual components (A) and (B), preferably herbicidally active compounds whose action is based on inhibition of, for example, acetolactate synthase, acetyl coenzyme A carboxylase, cellulose synthase, enolpyruvylshikimate 3-phosphate synthase, glutamine synthetase, p-hydroxyphenylpyruvate dioxygenase, phytoene desaturase, photosystem I, photosystem II, protoporphyrinogen oxidase, as described, for example, in Weed Research 26 (1986) 441-445 or “The Pesticide Manual”, 13^{th} edition 2003 or 14^{th} edition 2006/2007, or in the corresponding “The e-Pesticide Manual”, version 4.0 (2006-07), all published by the British Crop Protection Council, and the literature cited therein. Lists of common names are also available in “The Compendium of Pesticide Common Names” on the internet. Here, the herbicides are referred to either by the “common name” in accordance with the International Organization for Standardization (ISO) or by the chemical name or by the code number, and in each case include all use forms, such as acids, salts, esters and isomers, such as stereoisomers and optical isomers. Here, by way of example, one and in some cases a plurality of use forms are mentioned: acetochlor, acibenzolar, acibenzolar-5-methyl, acifluorten, acifluorten-sodium, aclonifen, alachlor, allidochlor, alloxydim, alloxydim-sodium, ametryne, amicarbazone, amidochlor, amidosulfuron, aminocyclopyrachlor, aminopyralid, amitrole, ammonium sulfamate, ancymidol, anilofos, asulam, atrazine, azafenidin, azimsulfuron, aziprotryne, BAH-043, BAS-140H, BAS-693H, BAS-714H, BAS-762H, BAS-776H, beflubutamid, benazolin, benazolin-ethyl, bencarbazone, benfluralin, benfuresate, bensulide, bensulfuron-methyl, bentazone, benzfendizone, benzobicyclon, benzofenap, benzofluor, benzoylprop, bifenox, bilanafos, bilanafos-sodium, bispyribac, bispyribac-sodium, bromacil, bromobutide, bromofenoxim, bromoxynil, bromuron, buminafos, busoxinone, butachlor, butafenacil, butamifos, butenachlor, butralin, butroxydim, butylate, cafenstrole, carbetamide, cartentrazone, cartentrazone-ethyl, chlomethoxyfen, chloramben, chlorazifop, chlorazifop-butyl, chlorbromuron, chlorbufam, chlortenac, chlortenac-sodium, chlortenprop, chlortlurenol, chlortlurenol-methyl, chloridazon, chlorimuron, chlorimuron-ethyl, chlormequat-chloride, chlornitrofen, chlorophthalim, chlorthal-dimethyl, chlorotoluron, chlorsulfuron, cinidon, cinidon-ethyl, cinmethylin, cinosulfuron, clethodim, clodinafop, clodinafop-propargyl, clofencet, clomazone, clomeprop, cloprop, clopyralid, cloransulam, cloransulam-methyl, cumyluron, cyanamide, cyanazine, cyclanilide, cycloate, cyclosulfamuron, cycloxydim, cycluron, cyhalofop, cyhalofop-butyl, cyperquat, cyprazine, cyprazole, 2,4-D, 2,4-DB, daimuron/dymron, dalapon, daminozide, dazomet, n-decanol, desmedipham, desmetryn, detosyl-pyrazolate (DTP), diallate, dicamba, dichlobenil, dichlorprop, dichlorprop-P, diclofop, diclofop-methyl, diclofop-P-methyl, diclosulam, diethatyl, diethatyl-ethyl, difenoxuron, difenzoquat, diflufenican, diflufenzopyr, diflufenzopyr-sodium, dimefuron, dikegulac-sodium, dimefuron, dimepiperate, dimethachlor, dimethametryn, dimethenamid, dimethenamid-P, dimethipin, dimetrasulfuron, dinitramine, dinoseb, dinoterb, diphenamid, dipropetryn, diquat, diquat-dibromide, dithiopyr, diuron, DNOC, eglinazine-ethyl, endothal, EPTC, esprocarb, ethalfluralin, ethametsulfuron-methyl, ethephon, ethidimuron, ethiozin, ethofumesate, ethoxyfen, ethoxyfen-ethyl, ethoxysulfuron, etobenzanid, F-5331, i.e. N-[2-chloro-4-fluoro-5-[4-(3-fluoropropyl)-4,5-dihydro-5-oxo-1H-tetrazol-1-yl]phenyl]ethanesulfonamide, fenoprop, fenoxaprop, fenoxaprop-P, fenoxaprop-ethyl, fenoxaprop-P-ethyl, fentrazamide, fenuron, flamprop, flamprop-M-isopropyl, flamprop-M-methyl, flazasulfuron, florasulam, fluazifop, fluazifop-P, fluazifop-butyl, fluazifop-P-butyl, fluazolate, flucarbazone, flucarbazone-sodium, flucetosulfuron, fluchloralin, flufenacet (thiafluamide), flufenpyr, flufenpyr-ethyl, flumetralin, flumetsulam, flumiclorac, flumiclorac-pentyl, flumioxazin, flumipropyn, fluometuron, fluorodifen, fluoroglycofen, fluoroglycofen-ethyl, flupoxam, flupropacil, flupropanate, flupyrsulfuron, flupyrsulfuron-methyl-sodium, flurenol, flurenol-butyl, fluridone, fluorochloridone, fluoroxypyr, fluoroxypyr-meptyl, flurprimidol, flurtamone, fluthiacet, fluthiacet-methyl, fluthiamide, fomesafen, foramsulfuron, forchlorfenuron, fosamine, furyloxyfen, gibberellic acid, glufosinate, glufosinate-ammonium glufosinate-P, glufosinate-P-ammonium, glufosinate-P-sodium, glyphosate, glyphosate-isopropylammonium, H-9201, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HNPC-9908, HW-02, imazamethabenz, imazamethabenz-methyl, imazamox, imazapic, imazapyr, imazaquin, imazethapyr, imazosulfuron, inabenfide, indanofan, indoleacetic acid (IAA), 4-indol-3-ylbutyric acid (IBA), iodosulfuron, iodosulfuron-methyl-sodium, ioxynil, ipfencarbazone, isocarbamid, isopropalin, isoproturon, isouron, isoxaben, isoxachlortole, isoxaflutole, isoxapyrifop, KUH-043, KUH-071, karbutilate, ketospiradox, lactofen, lenacil, linuron, maleic hydrazide, MCPA, MCPB, MCPB-methyl, -ethyl and -sodium, mecoprop, mecoprop-sodium, mecoprop-butotyl, mecoprop-P-butotyl, mecoprop-P-dimethylammonium, mecoprop-P-2-ethylhexyl, mecoprop-P-potassium, mefenacet, mefluidide, mepiquat-chloride, mesosulfuron, mesosulfuron-methyl, mesotrione, methabenzthiazuron, metam, metamifop, metamitron, metazachlor, methazole, methoxyphenone, methyldymron, 1-methylcyclopropene, methyl isothiocyanate, metobenzuron, metobromuron, metolachlor, S-metolachlor, metosulam, metoxuron, metribuzin, metsulfuron, metsulfuron-methyl, molinate, monalide, monocarbamide, monocarbamide dihydrogen sulfate, monolinuron, monosulfuron, monuron, MT 128, MT-5950, i.e. N-[3-chloro-4-(1-methylethyl)phenyl]-2-methylpentanamide, NGGC-011, naproanilide, napropamide, naptalam, NC-310, i.e. 4-(2,4-dichlorobenzoyl)-1-methyl-5-benzyloxypyrazole, neburon, nicosulfuron, nipyraclofen, nitralin, nitrofen, nitrophenolat-sodium (isomer mixture), nitrofluorfen, nonanoic acid, norflurazon, orbencarb, orthosulfamuron, oryzalin, oxadiargyl, oxadiazon, oxasulfuron, oxaziclomefone, oxyfluorfen, paclobutrazole, paraquat, paraquat dichloride, pelargonic acid (nonanoic acid), pendimethalin, pendralin, penoxsulam, pentanochlor, pentoxazone, perfluidone, pethoxamid, phenisopham, phenmedipham, phenmedipham-ethyl, picloram, picolinafen, pinoxaden, piperophos, pirifenop, pirifenop-butyl, pretilachlor, primisulfuron, primisulfuron-methyl, probenazole, profluazol, procyazine, prodiamine, prifluraline, profoxydim, prohexadione, prohexadione-calcium, prohydrojasmone, prometon, prometryn, propachlor, propanil, propaquizafop, propazine, propham, propisochlor, propoxycarbazone, propoxycarbazone-sodium, propyzamide, prosulfalin, prosulfocarb, prosulfuron, prynachlor, pyraclonil, pyraflufen, pyraflufen-ethyl, pyrasulfotole, pyrazolynate (pyrazolate), pyrazosulfuron-ethyl, pyrazoxyfen, pyribambenz, pyribambenz-isopropyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, rimsulfuron, saflufenacil, secbumeton, sethoxydim, siduron, simazine, simetryn, SN-106279, sulcotrione, sulfallate (CDEC), sulfentrazone, sulfometuron, sulfometuron-methyl, sulfosate (glyphosate-trimesium), sulfosulfuron, SYN-449, SYN-523, SYP-249, SYP-298, SYP-300, tebutam, tebuthiuron, tecnazene, tefuryltrione, tembotrione, tepraloxydim, terbacil, terbucarb, terbuchlor, terbumeton, terbuthylazine, terbutryne, TH-547, thenylchlor, thiafluamide, thiazafluoron, thiazopyr, thidiazimin, thidiazuron, thiencarbazone, thiencarbazone-methyl, thifensulfuron, thifensulfuron-methyl, thiobencarb, tiocarbazil, topramezone, tralkoxydim, triallate, triasulfuron, triaziflam, triazofenamide, tribenuron, tribenuron-methyl, trichloroacetic acid (TCA), triclopyr, tridiphane, trietazine, trifloxysulfuron, trifloxysulfuron-sodium, trifluralin, triflusulfuron, triflusulfuron-methyl, trimeturon, trinexapac, trinexapac-ethyl, tritosulfuron, tsitodef, uniconazole, uniconazole-P, vernolate, ZJ-0166, ZJ-0270, ZJ-0543, ZJ-0862 and the following compounds

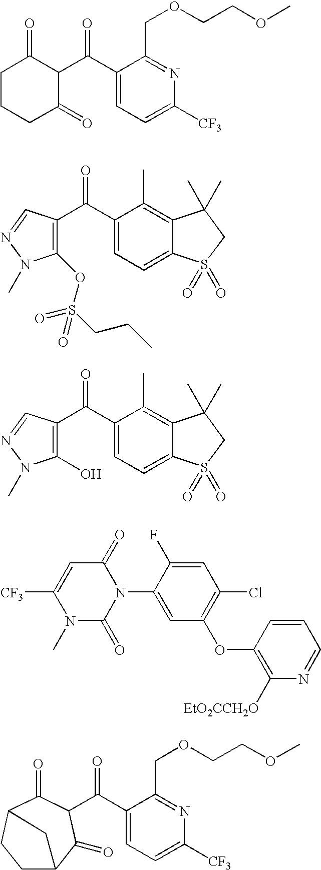

The weight ratios of the herbicides (A) which differ structurally from components (A) and (B) to the herbicide/safener combination generally depend on the herbicide application rate and the effectiveness of the safener in question and may vary within wide limits, for example in the range from 1:50000 to 500:1, preferably from 1:8000 to 250:1, in particular from 1:2500 to 50:1. These mixtures may be formulated analogously to the components of the herbicide/safener combination with other herbicides/pesticides and be provided and used as a finished formulation or as a tank mix with the herbicides or separately be applied as a seed, soil or foliar application.

The herbicide/safener combinations according to the invention (=herbicidal compositions) have excellent herbicidal activity against a broad spectrum of economically important monocotyledonous and dicotyledonous harmful plants, such as broad-leaved weeds, weed grasses or Cyperaceae, including species which are resistant to herbicidally active compounds such as glyphosate, glufosinate, atrazine, imidazolinone herbicides, sulfonylureas, (hetero)aryloxyaryloxyalkylcarboxylic acids or -phenoxyalkylcarboxylic acids (‘fops’), cyclohexanedione oximes (‘dims’) or auxin inhibitors. The active compounds also act efficiently on perennial weeds which produce shoots from rhizomes, root stocks and other perennial organs and which are difficult to control. Here, the substances can be applied, for example, by the pre-sowing method, the pre-emergence method or the post-emergence method, for example jointly or separately. Preference is given, for example, to application by the post-emergence method, in particular to the emerged harmful plants.

Specific examples may be mentioned of some representatives of the monocotyledonous and dicotyledonous weed flora which can be controlled by the compounds according to the invention, without the enumeration being restricted to certain species.

Examples of weed species on which the herbicidal compositions act efficiently are, from amongst the monocotyledonous weed species, Avena spp., Alopecurus spp., Apera spp., Brachiaria spp., Bromus spp., Digitaria spp., Lolium spp., Echinochloa spp., Leptochloa spp., Fimbristylis spp., Panicum spp., Phalaris spp., Poa spp., Setaria spp. and also Cyperus species from the annual group, and, among the perennial species, Agropyron, Cynodon, Imperata and Sorghum and also perennial Cyperus species.

In the case of the dicotyledonous weed species, the spectrum of action extends to genera such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp. Eclipta spp., Sesbania spp., Aeschynomene spp. and Viola spp., Xanthium spp. among the annuals, and Convolvulus, Cirsium, Rumex and Artemisia in the case of the perennial weeds.

If the active compounds of the herbicide/safener combinations according to the invention are applied to the soil surface before germination, the weed seedlings are either prevented completely from emerging or else the weeds grow until they have reached the cotyledon stage, but then their growth stops, and, eventually, after two to four weeks have elapsed, they die completely.

If the active compounds are applied post-emergence to the green parts of the plants, growth likewise stops drastically a very short time after the treatment, and the weed plants remain at the growth stage of the point of time of application, or they die completely after a certain time, so that in this manner competition by the weeds, which is harmful to the crop plants, is eliminated very early and in a sustained manner. In the case of rice, the active compounds can also be applied into the water, and they are then taken up via soil, shoot and roots.

The herbicide/safener combinations according to the invention are distinguished by a rapidly commencing and long-lasting herbicidal action. As a rule, the rainfastness of the active compounds in the combinations according to the invention is favorable. A particular advantage is that the dosages used in the combinations and the effective dosages of compounds (A) and (B) can be adjusted to such a low level that their soil action is optimally low. This does not only allow them to be employed in sensitive crops in the first place, but ground water contaminations are virtually avoided. The combinations according to the invention of active compounds allow the required application rate of the active compounds to be reduced considerably.

In a preferred embodiment, the herbicide/safener combinations according to the invention of the individual components (A) and (B) are highly suitable for the selective control of harmful plants in rice crops. These include all possible forms of rice cultivation under the most diverse conditions, such as upland cultivation, dry cultivation or paddy cultivation, where the irrigation may be natural (rainfall) and/or artificial (irrigated, flooded). The rice used for this purpose may be conventionally cultivated seed, hybrid seed, or else resistant, at least tolerant, seed (obtained by mutagenesis or transgenically) which can be derived from the indica or japonica variety or from crossbreeds thereof.

The herbicide/safener combinations according to the invention can be applied by all application methods customary for rice herbicides. Particularly preferably, they are applied by spray application and/or by submerged application. In the submerged application, the paddy water already covers the ground by up to 3-20 cm at the time of the application. The herbicide/safener combinations according to the invention are then directly placed in the paddy water, for example in the form of granules. Worldwide, the spray application is used predominantly with direct seeded rice and the submerged application is used predominantly with transplanted rice.

The herbicide/safener combinations according to the invention cover a broad weed spectrum which is specific in particular for rice crops. From among the monocotyledonous weeds, genera such as, for example, Echinochloa spp., Panicum spp., Poa spp., Leptochloa spp., Brachiaria spp., Digitaria spp., Setaria spp. Cyperus spp., Monochoria spp., Fimbristylis spp., Sagittaria spp., Eleocharis spp., Scirpus spp., Alisma spp., Aneilema spp., Blyxa spp., Eriocaulon spp., Potamogeton spp. and the like are controlled well, in particular the species Echinochloa oryzicola, Monochoria vaginalis, Eleocharis acicularis, Eleocharis kuroguwai, Cyperus difformis, Cyperus serotinus, Sagittaria pygmaea, Alisma canaliculatum, Scirpus juncoides. In the case of the dicotyledonous weeds, the activity spectrum extends to genera such as, for example, Polygonum spp., Rorippa spp., Rotala spp., Lindernia spp., Bidens spp., Sphenoclea spp., Dopatrium spp., Eclipta spp., Elatine spp., Gratiola spp., Lindernia spp., Ludwigia spp., Oenanthe spp., Ranunculus spp., Deinostema spp. and the like. In particular species such as Rotala indica, Sphenoclea zeylanica, Lindernia procumbens, Ludwigia prostrate, Potamogeton distinctus, Elatine triandra, Oenanthe javanica are controlled well.

The improved crop plant compatibility of the herbicide/safener combination also permits the application rates to be increased, which, in single applications of the herbicides, allows a number of positive effects to be achieved: higher efficacy and/or longer persistency; the control of a wider spectrum of broad-leaved weeds, weed grasses and Cyperaceae; a more rapid onset of the herbicidal action; the control of species which were as yet uncontrolled (gaps); the control of, for example, species which are tolerant or resistant to individual herbicides or to a number of herbicides; an extension of the period of application and/or a reduction in the number of individual applications required and as a result for the user weed control systems which are more advantageous economically and ecologically.

The abovementioned properties and advantages are necessary for weed control practice to keep agricultural/forestry/horticultural crops or green land/meadows free of unwanted competing plants, and thus to ensure and/or increase yield levels from the qualitative and quantitative angle. These novel herbicide/safener combinations markedly exceed the technical state of the art with a view to the properties described.

Owing to their herbicidal and plant growth-regulatory properties, the herbicide/safener combinations according to the invention can also be employed for controlling harmful plants in known plant crops or in tolerant or genetically modified crop and energy plants still to be developed. In general, the transgenic plants (GMOs) are distinguished by specific advantageous properties, in addition to resistances to the herbicide/safener combinations according to the invention, for example, by resistances to plant diseases or the causative organisms of plant diseases such as certain insects or microorganisms, such as fungi, bacteria or viruses. Other specific characteristics relate, for example, to the harvested material with regard to quantity, quality, storability, and the composition of specific constituents. Thus, transgenic plants are known whose starch content is increased, or whose starch quality is altered, or those where the harvested material has a different fatty acid composition, or increased vitamin content or energetic properties. In the same manner, owing to their herbicidal and plant growth-regulatory properties, the active compounds can also be used for controlling harmful plants in crops of known plants or plants still to be developed by mutant selection, and also crossbreeds of mutagenic and transgenic plants.

Conventional methods of generating novel plants which have modified properties in comparison to plants occurring to date consist, for example, in traditional breeding methods and the generation of mutants. Alternatively, novel plants with altered properties can be generated with the aid of recombinant methods (see, for example, EP-A-0221044, EP-A-0131624). For example, the following have been described in several cases:
the modification, by recombinant technology, of crop plants with the aim of modifying the starch synthesized in the plants (for example WO 92/11376, WO 92/14827, WO 91/19806),
transgenic crop plants which exhibit resistances to herbicides, for example to sulfonylureas (EP-A-0257993, U.S. Pat. No. 5,013,659),
transgenic crop plants with the capability of producing Bacillus thuringiensis toxins (Bt toxins), which make the plants resistant to certain pests (EP-A-0142924, EP-A-0193259),
transgenic crop plants with a modified fatty acid composition (WO 91/13972).

A large number of techniques in molecular biology are known in principle with the aid of which novel transgenic plants with modified properties can be generated; see, for example, Sambrook et al., 1989, Molecular Cloning, A Laboratory Manual, 2^{nd} Edition, Cold Spring Harbor Laboratory Press, Cold Spring Harbor, N.Y.; or Winnacker “Gene and Klone”, VCH Weinheim 2^{nd} Edition 1996 or Christou, “Trends in Plant Science” 1 (1996) 423-431). To carry out such recombinant manipulations, nucleic acid molecules which allow mutagenesis or sequence changes by recombination of DNA sequences can be introduced into plasmids. For example, the abovementioned standard methods allow base exchanges to be carried out, subsequences to be removed, or natural or synthetic sequences to be added. To connect the DNA fragments to each other, adapters or linkers may be added to the fragments.

For example, the generation of plant cells with a reduced activity of a gene product can be achieved by expressing at least one corresponding antisense RNA, a sense RNA for achieving a cosuppression effect or by expressing at least one suitably constructed ribozyme which specifically cleaves transcripts of the abovementioned gene product.

To this end, it is possible to use DNA molecules which encompass the entire coding sequence of a gene product inclusive of any flanking sequences which may be present, and also DNA molecules which only encompass portions of the coding sequence, it being necessary for these portions to be long enough to have an antisense effect in the cells. The use of DNA sequences which have a high degree of homology to the coding sequences of a gene product, but are not completely identical to them, is also possible.

When expressing nucleic acid molecules in plants, the protein synthesized can be localized in any desired compartment of the plant cell. However, to achieve localization in a particular compartment, it is possible, for example, to link the coding region with DNA sequences which ensure localization in a particular compartment. Such sequences are known to those skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106).

The transgenic plant cells can be regenerated by known techniques to give rise to entire plants. In principle, the transgenic plants can be plants of any desired plant species, i.e. not only monocotyledonous, but also dicotyledonous, plants. Thus, transgenic plants can be obtained whose properties are altered by overexpression, suppression or inhibition of homologous (=natural) genes or gene sequences or the expression of heterologous (=foreign) genes or gene sequences.

Accordingly, the invention also provides for the use of the herbicidally active composition according to the invention for controlling harmful plants in transgenic crop plants or crop plants which are tolerant as a result of selective breeding, and crossbreeds/hybrids of both.

The present invention furthermore provides a method for the selective control of unwanted plants, preferably in crop plants, in particular in rice crops (planted or sown under upland or paddy conditions using indica and/or japonica species and also hybrids/mutants/GMOs), which comprises applying the components (A) and (B) of the herbicide/safener combinations according to the invention to the plants (for example harmful plants, such as monocotyledonous or dicotyledonous broad-leaved weeds, weed grasses, Cyperaceae or unwanted crop plants), the seed (for example grains, seeds or vegetative propagation organs, such as tubers or shoot parts with buds) or to the area on which the plants grow (for example the area under cultivation, which may also be covered by water), for example together or separately. Here, one or more safeners (B), preferably one or more, in particular one, compound(s) of the formulae (S-1) to (S-13), and/or from group (B), is/are applied before, after or simultaneously with the herbicide(s) (A) to the plants, the seed or the area on which the plants grow (for example the area under cultivation). In a preferred embodiment, the safeners (B) are used for seed treatment.

Unwanted plants are to be understood as meaning all plants which grow in locations where they are unwanted. These can, for example, be harmful plants (for example monocotyledonous or dicotyledonous weeds, weed grasses, Cyperaceae or unwanted crop plants), including, for example, those which are resistant to certain herbicidally active compounds, such as glyphosate, glufosinate, atrazine, imidazolinone herbicides, sulfonylureas, (hetero)aryloxyaryloxyalkylcarboxylic acids or -phenoxyalkylcarboxylic acids (‘fops’), cyclohexanedione oximes (‘dims’) or auxin inhibitors.

The herbicide/safener combinations according to the invention are employed selectively for controlling unwanted vegetation, for example in crop plants such as farm crops, for example monocotyledonous farm crops, such as cereals (for example wheat, barley, rye, oats, rice, corn, millet), or dicotyledonous farm crops, such as sugar beet, sugar cane, oilseed rape, cotton, sunflowers and leguminous plants, for example of the genera Glycine (for example Glycine max. (soybean), such as non-transgenic Glycine max. (for example conventional cultivars, such as STS cultivars) or transgenic Glycine max. (for example RR-soybean or LL-soybean) and crossbreeds thereof), Phaseolus, Pisum, Vicia and Arachis, or vegetable crops from various botanical groups, such as potato, leek, cabbage, carrot, tomato, onion, in fruit plantations (plantation crops), or on greens, lawns and pasture areas, in particular in rice crops (planted or sown under upland or paddy conditions using indica and/or japonica varieties and also hybrids/mutants/GMOs). The application is preferably carried out both prior to the emergence of the harmful plants and to the emerged harmful plants (for example broad-leaved weeds, weed grasses, Cyperaceae or unwanted crop plants), independently of the stage of the sown/planted crop.

The invention also provides the use of the herbicide/safener combinations according to the invention for selectively controlling unwanted vegetation, preferably in crop plants, in particular in rice crops (planted or sown under upland or paddy conditions using indica and/or japonica varieties and also hybrids/mutants/GMOs).

The present invention furthermore provides a method for improving crop plant compatibility, preferably in crop plants, in particular in rice crops (planted or sown under upland or paddy conditions using indica and/or japonica species and also hybrids/mutants/GMOs), which comprises applying the components (A) and (B) of the herbicide/safener combinations according to the invention to the plants (for example harmful plants, such as monocotyledonous or dicotyledonous broad-leaved weeds, weed grasses, Cyperaceae or unwanted crop plants), the seed (for example grains, seeds or vegetative propagation organs, such as tubers or shoot parts with buds) or to the area on which the plants grow (for example the area under cultivation, which may also be covered by water), for example together or separately. Here, one or more safeners (B), preferably one or more, in particular one, compound(s) of the formulae (S-1) to (S-13), and/or from group (B), is/are applied before, after or simultaneously with the herbicide(s) (A) to the plants, the seed or the area on which the plants grow (for example the area under cultivation). In a preferred embodiment, the safeners (B) are used for seed treatment.

The invention also provides the use of the herbicide/safener combinations according to the invention for improving crop plant compatibility, preferably in crop plants, in particular in rice crops (planted or sown under upland or paddy conditions using indica and/or japonica varieties and also hybrids/mutants/GMOs).

The herbicide/safener combinations according to the invention can be prepared by known processes, for example as mixed formulations of the individual components, if appropriate with further active compounds, additives and/or customary formulation auxiliaries, which combinations are then applied in a customary manner diluted with water, or as tank mixes by joint dilution of the individual components, formulated separately or formulated partially separately, with water. Also possible is the split application of the separately formulated or partially separately formulated individual components. It is also possible to use the individual components or the herbicide/safener combinations in a plurality of portions (sequential application), for example pre-emergence applications followed by post-emergence applications or early post-emergence applications followed by medium or late post-emergence applications. Preference is given here to the joint or almost simultaneous use of the active compounds of the combination in question, and the joint use is particularly preferred.

The herbicides (A) and safeners (B) can be converted jointly or separately into customary formulations, such as solutions, emulsions, suspensions, powders, foams, pastes, granules, aerosols, natural and synthetic materials impregnated with active compound and microencapsulations in polymeric materials. Mention may also be made of formulations specific for the cultivation of rice, such as, for example, granules for scattering, jumbo granules, floating granules, floating suspoemulsions applied via shaker bottles and dissolved in and distributed via the paddy water. The formulations may comprise the customary auxiliaries and additives.

These formulations are produced in a known manner, for example by mixing the active compounds with extenders, that is, liquid solvents, liquefied gases under pressure, and/or solid carriers, optionally with the use of surfactants, that is emulsifiers and/or dispersants, and/or foam formers.

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulfoxide, and also water.

Suitable solid carriers are: for example ammonium salts and ground natural minerals such as kaolins, clays, talc, chalk, quartz, attapulgite, montmorillonite or diatomaceous earth, and ground synthetic minerals such as highly-disperse silica, alumina and silicates; suitable solid carriers for granules are: for example crushed and fractionated natural rocks such as calcite, marble, pumice, sepiolite and dolomite, and also synthetic granules of inorganic and organic meals, and granules of organic material such as sawdust, coconut shells, maize cobs and tobacco stalks; suitable emulsifiers and/or foam-formers are: for example nonionic and anionic emulsifiers, such as polyoxyethylene fatty acid esters, polyoxyethylene fatty alcohol ethers, for example alkylaryl polyglycol ethers, alkyl sulfonates, alkyl sulfates, aryl sulfonates, and also protein hydrolysates; suitable dispersants are: for example lignosulphite waste liquors and methyl cellulose.

Tackifiers, such as carboxymethyl cellulose, natural and synthetic polymers in the form of powders, granules or latices, such as gum arabic, polyvinyl alcohol and polyvinyl acetate, and also natural phospholipids, such as cephalins and lecithins, and synthetic phospholipids can be used in the formulations. Other possible additives are mineral and vegetable oils.

The herbicidal action of the herbicide/safener combinations according to the invention can likewise be improved, for example, by surfactants, preferably by wetting agents from the group of the fatty alcohol polyglycol ethers. The fatty alcohol polyglycol ethers preferably comprise 10-18 carbon atoms in the fatty alcohol radical and 2-20 ethylene oxide units in the polyglycol ether moiety. The fatty alcohol polyglycol ethers may be present in nonionic form, or ionic form, for example in the form of fatty alcohol polyglycol ether sulfates, which may be used, for example, as alkali metal salts (for example sodium salts and potassium salts) or ammonium salts, or even as alkaline earth metal salts, such as magnesium salts, such as C₁₂/C₁₄-fatty alcohol diglycol ether sulfate sodium (Genapol® LRO, Clariant GmbH); see, for example, EP-A-0476555, EP-A-0048436, EP-A-0336151 or U.S. Pat. No. 4,400,196 and also Proc. EWRS Symp. “Factors Affecting Herbicidal Activity and Selectivity”, 227-232 (1988). Nonionic fatty alcohol polyglycol ethers are, for example, (C₁₀-C₁₈)-, preferably (C₁₀-C₁₄)-fatty alcohol polyglycol ethers (for example isotridecyl alcohol polyglycol ethers) which comprise, for example, 2-20, preferably 3-15, ethylene oxide units, for example those from the Genapol® X-series, such as Genapol® X-030, Genapol® X-060, Genapol® X-080 or Genapol® X-150 (all from Clariant GmbH).

The present invention further comprises the combination of components (A) and (B) with the wetting agents mentioned above from the group of the fatty alcohol polyglycol ethers which preferably contain 10-18 carbon atoms in the fatty alcohol radical and 2-20 ethylene oxide units in the polyglycol ether moiety and which may be present in nonionic or ionic form (for example as fatty alcohol polyglycol ether sulfates). Preference is given to C₁₂/C₁₄-fatty alcohol diglycol ether sulfate sodium (Genapol® LRO, Clariant GmbH) and isotridecyl alcohol polyglycol ether having 3-15 ethylene oxide units, for example from the Genapol® X-series, such as Genapol® X-030, Genapol® X-060, Genapol® X-080 and Genapol® X-150 (all from Clariant GmbH).

Furthermore, it is known that fatty alcohol polyglycol ethers, such as nonionic or ionic fatty alcohol polyglycol ethers (for example fatty alcohol polyglycol ether sulfates) are also suitable for use as penetrants and activity enhancers for a number of other herbicides (see, for example, EP-A-0502014). Accordingly, the present invention also embraces the combination with suitable penetrants and activity enhancers, preferably in commercially available form.

The herbicide/safener combinations according to the invention can also be used together with vegetable oils. The term vegetable oils is to be understood as meaning oils of oleaginous plant species, such as soybean oil, rapeseed oil, corn oil, sunflower oil, cottonseed oil, linseed oil, coconut oil, palm oil, thistle oil or castor oil, in particular rapeseed oil, and also their transesterification products, for example alkyl esters, such as rapeseed oil methyl ester or rapeseed oil ethyl ester.

The vegetable oils are preferably esters of C₁₀-C₂₂-, preferably C₁₂-C₂₀-, fatty acids. The C₁₀-C₂₂-fatty acid esters are, for example, esters of unsaturated or saturated C₁₀-C₂₂-fatty acids, in particular those having an even number of carbon atoms, for example erucic acid, lauric acid, palmitic acid and in particular C₁₈-fatty acids, such as stearic acid, oleic acid, linoleic acid or linolenic acid.

Examples of C₁₀-C₂₂-fatty acid esters are esters obtained by reacting glycerol or glycol with the C₁₀-C₂₂-fatty acids contained, for example, in oils of oleaginous plant species, or C₁-C₂₀-alkyl-C₁₀-C₂₂-fatty acid esters which can be obtained, for example, by transesterification of the aforementioned glycerol- or glycol-C₁₀-C₂₂-fatty acid esters with C₁-C₂₀-alcohols (for example methanol, ethanol, propanol or butanol). The transesterification can be carried out by known methods as described, for example, in Römpp Chemie Lexikon, 9th edition, Volume 2, page 1343, Thieme Verlag Stuttgart.

Preferred C₁-C₂₀-alkyl-C₁₀-C₂₂-fatty acid esters are methyl esters, ethyl esters, propyl esters, butyl esters, 2-ethylhexyl esters and dodecyl esters. Preferred glycol- and glycerol-C₁₀-C₂₂-fatty acid esters are the uniform or mixed glycol esters and glycerol esters of C₁₀-C₂₂-fatty acids, in particular fatty acids having an even number of carbon atoms, for example erucic acid, lauric acid, palmitic acid and, in particular, C₁₈-fatty acids, such as stearic acid, oleic acid, linoleic acid or linolenic acid.

In the herbicidal compositions according to the invention, the vegetable oils can be present, for example, in the form of commercially available oil-containing formulation additives, in particular those based on rapeseed oil, such as Hasten® (Victorian Chemical Company, Australia, hereinbelow referred to as Hasten, main ingredient: rapeseed oil ethyl ester), Actirob®B (Novance, France, hereinbelow referred to as ActirobB, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

In a further embodiment, the present invention also comprises combinations with the vegetable oils mentioned above, such as rapeseed oil, preferably in the form of commercially available oil-containing formulation additives, in particular those based on rapeseed oil, such as Hasten® (Victorian Chemical Company, Australia, hereinbelow referred to as Hasten, main ingredient: rapeseed oil ethyl ester), Actirob®B (Novance, France, hereinbelow referred to as ActirobB, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

It is possible to use colorants such as inorganic pigments, for example iron oxide, titanium oxide and Prussian Blue, and organic colorants such as alizarin colorants, azo colorants and metal phthalocyanine colorants, and trace nutrients such as salts of iron, manganese, boron, copper, cobalt, molybdenum and zinc.

In general, the formulations comprise between 0.1 and 95% by weight of active compound, preferably between 0.5 and 90% by weight.

As such or in their formulations, the individual components (A) and (B) can also be used as a mixture with other agrochemically active compounds, such as known herbicides, for controlling unwanted vegetation, for example for controlling weeds or for controlling unwanted crop plants, finished formulations or tank mixes, for example, being possible.

Mixtures with other known active compounds, such as fungicides, insecticides, acaricides, nematicides, safeners, bird repellents, plant nutrients and agents which improve soil structure, are also possible.

The individual components (A) and (B) can be used as such, in the form of their formulations or in the use forms prepared therefrom by further dilution, such as ready-to-use solutions, suspensions, emulsions, powders, pastes and granules. They are used in a customary manner, for example by watering, spraying, atomizing or broadcasting.

The active compounds can be applied to the plants (for example harmful plants, such as monocotyledonous or dicotyledonous broad-leaved weeds, weed grasses, Cyperaceae or unwanted crop plants), the seed (for example grains, seeds or vegetative propagation organs, such as tubers or shoot parts with buds) or the area under cultivation (for example the soil), preferably to the green plants and parts of plants and, if appropriate, additionally the soil. One possible use is the joint application of the active compounds in the form of tank mixes, where the optimally formulated concentrated formulations of the individual active compounds are, together, mixed in a tank with water, and the spray liquor obtained is applied.

A joint herbicidal formulation of the combination according to the invention with the individual components (A) and (B) has the advantage that it is easier to apply, since the amounts of the components can already be set in an optimum ratio. Moreover, the auxiliaries in the formulation can be adjusted optimally to one another.

### BIOLOGICAL EXAMPLES

### Crop Plant Compatibility when applied by the Post-Emergence Method

### Method

Seeds of crop plants were placed in sandy loam and then covered with soil. The pots were placed in a greenhouse and kept under good growth conditions for the crop plants. Two weeks after sowing, the test plants were treated at the 1-3 leaf stage. The active compounds of components (A) and (B), formulated in the form of wettable powders, were then sprayed as aqueous suspensions at various dosages onto the green parts of the plants, using an application rate of 300 l of water/ha (converted).

The visual scoring of the herbicidal effects in the combination with or without safener was carried out after the number of days stated in the tables (DAT=days after treatment). Scoring was carried out in percent in comparison to the untreated control plants (herbicidal activity in %). 0%=no herbicidal activity, 100%=complete herbicidal activity=complete kill.

The safener action was calculated by comparing the herbicidal activity in % of the herbicide combination without (individual compound) and with safener (combination). The difference of the herbicidal activity in % between the individual compound and the combination was then calculated in percent (safener action in %): 0%=no improvement by addition of safener, 100%=complete improvement by addition of safener=maximum crop plant compatibility.

### Results

The combinations according to the invention of herbicides of group (A) (component A) with safeners from group (B) (component B) were tested using a broad spectrum of useful plants and showed improved crop plant compatibility (safener action in %; see the tables below):

TABLE 1
Crop plant wheat (cultivar: Triso)

| | Individual | Component A dosage | Component B dosage | Herbicidal | Safener |
|---|---|---|---|---|---|
| | compound or | herbicide (A . . .) | safener (S . . .) | activity in | action in |
| DAT | combination | [g of ai/ha] | [g of ai/ha] | % | % |
| 17 | compound (A-3) | 20 | — | 20 | 75 |
| | (A-3) + (S1-1) | 20 | 100 | 5 | |
| | mefenpyr(-diethyl) | | | | |
| 17 | compound (A-3) | 20 | — | 20 | 60 |
| | (A-3) + (S1-12) | 20 | 100 | 8 | |
| | isoxadifen(-ethyl) | | | | |
| 17 | compound (A-3) | 2.2 | — | 8 | 100 |
| | (A-3) + (S4-1) | 2.2 | 100 | 0 | |
| | cyprosulfamide | | | | |
| 17 | compound (A-3) | 20 | — | 20 | 50 |
| | (A-3) + (S2-1) | 20 | 100 | 10 | |
| | cloquintocet(-mexyl) | | | | |
| 10 | compound (A-3) | 6.7 | — | 5 | 100 |
| | (A-3) + (S3-4) | 6.7 | 100 | 0 | |
| | benoxacor | | | | |
| 17 | compound (A-3) | 20 | — | 20 | 25 |
| | (A-3) + | 20 | 100 | 15 | |
| | (S3-10)/(S3-11) | | | | |
| | furilazole | | | | |
| 10 | compound (A-3) | 6.7 | — | 5 | 100 |
| | (A-3) + (S11-2) | 6.7 | 100 | 0 | |
| | fluxofenim | | | | |
| 10 | compound (A-3) | 6.7 | — | 5 | 100 |
| | (A-3) + (S1-7) | 6.7 | 100 | 0 | |
| | fenchlorazole(-ethyl) | | | | |

Notes:
DAT = days after treatment (time of assessment); [g of ai/ha] = gramm of active substance per hectare

TABLE 2
Crop plant barley (cultivar: Adonis)

| | Individual | Component A dosage | Component B dosage | Herbicidal | Safener |
|---|---|---|---|---|---|
| | compound or | herbicide (A . . .) | safener (S . . .) | activity in | action in |
| DAT | combination | [g of ai/ha] | [g of ai/ha] | % | % |
| 17 | compound (A-3) | 20 | — | 20 | 100 |
| | (A-3) + (S1-1) | 20 | 100 | 0 | |
| | mefenpyr(-diethyl) | | | | |
| 17 | compound (A-3) | 20 | — | 20 | 100 |
| | (A-3) + (S1-12) | 20 | 100 | 0 | |
| | isoxadifen(-ethyl) | | | | |
| 17 | compound (A-3) | 6.7 | — | 10 | 50 |
| | (A-3) + (S4-1) | 6.7 | 100 | 5 | |
| | cyprosulfamide | | | | |
| 17 | compound (A-3) | 20 | — | 20 | 60 |
| | (A-3) + (S2-1) | 20 | 100 | 8 | |
| | cloquintocet(-mexyl) | | | | |
| 17 | compound (A-3) | 20 | — | 20 | 35 |
| | (A-3) + (S3-4) | 20 | 100 | 13 | |
| | benoxacor | | | | |
| 17 | compound (A-3) | 6.7 | — | 10 | 100 |
| | (A-3) + | 6.7 | 100 | 0 | |
| | (S3-10)/(S3-11) | | | | |
| | furilazole | | | | |
| 17 | compound (A-3) | 6.7 | — | 10 | 70 |
| | (A-3) + (S11-2) | 6.7 | 100 | 3 | |
| | fluxofenim | | | | |
| 17 | compound (A-3) | 6.7 | — | 10 | 50 |
| | (A-3) + (S1-7) | 6.7 | 100 | 5 | |
| | fenchlorazole(-ethyl) | | | | |

Notes:
DAT = days after treatment (time of assessment); [g of ai/ha] = gramm of active substance per hectare

TABLE 3
Crop plant corn (cultivar: Oldham)

| | Individual | Component A dosage | Component B dosage | Herbicidal | Safener |
|---|---|---|---|---|---|
| | compound or | herbicide (A . . .) | safener (S . . .) | activity in | action in |
| DAT | combination | [g of ai/ha] | [g of ai/ha] | % | % |
| 17 | compound (A-3) | 20 | — | 30 | 23 |
| | (A-3) + (S1-1) | 20 | 100 | 23 | |
| | mefenpyr(-diethyl) | | | | |
| 17 | compound (A-3) | 20 | — | 30 | 100 |
| | (A-3) + (S1-12) | 20 | 100 | 0 | |
| | isoxadifen(-ethyl) | | | | |
| 17 | compound (A-3) | 20 | — | 30 | 100 |
| | (A-3) + (S4-1) | 20 | 100 | 0 | |
| | cyprosulfamide | | | | |
| 17 | compound (A-3) | 20 | — | 30 | 57 |
| | (A-3) + (S2-1) | 20 | 100 | 13 | |
| | cloquintocet(-mexyl) | | | | |
| 17 | compound (A-3) | 20 | — | 30 | 90 |
| | (A-3) + (S3-4) | 20 | 100 | 3 | |
| | benoxacor | | | | |
| 17 | compound (A-3) | 20 | — | 30 | 50 |
| | (A-3) + | 20 | 100 | 15 | |
| | (S3-10)/(S3-11) | | | | |
| | furilazole | | | | |
| 17 | compound (A-3) | 20 | — | 30 | 100 |
| | (A-3) + (S11-2) | 20 | 100 | 0 | |
| | fluxofenim | | | | |
| 17 | compound (A-3) | 20 | — | 30 | 73 |
| | (A-3) + (S1-7) | 20 | 100 | 8 | |
| | fenchlorazole(-ethyl) | | | | |

Notes:
DAT = days after treatment (time of assessment); [g of ai/ha] = gramm of active substance per hectare

TABLE 4
Crop plant rice (cultivar: Rice Ballila)

| | Individual | Component A dosage | Component B dosage | Herbicidal | Safener |
|---|---|---|---|---|---|
| | compound or | herbicide (A . . .) | safener (S . . .) | activity in | action in |
| DAT | combination | [g of ai/ha] | [g of ai/ha] | % | % |
| 17 | compound (A-3) | 20 | — | 50 | 20 |
| | (A-3) + (S1-1) | 20 | 100 | 40 | |
| | mefenpyr(-diethyl) | | | | |
| 10 | compound (A-3) | 2.2 | — | 30 | 33 |
| | (A-3) + (S1-12) | 2.2 | 100 | 20 | |
| | isoxadifen(-ethyl) | | | | |
| 10 | compound (A-3) | 2.2 | — | 30 | 100 |
| | (A-3) + (S4-1) | 2.2 | 100 | 0 | |
| | cyprosulfamide | | | | |
| 10 | compound (A-3) | 2.2 | — | 30 | 100 |
| | (A-3) + (S2-1) | 2.2 | 100 | 0 | |
| | cloquintocet(-mexyl) | | | | |
| 10 | compound (A-3) | 2.2 | — | 30 | 100 |
| | (A-3) + (S3-4) | 2.2 | 100 | 0 | |
| | benoxacor | | | | |
| 10 | compound (A-3) | 2.2 | — | 30 | 100 |
| | (A-3) + | 2.2 | 100 | 0 | |
| | (S3-10)/(S3-11) | | | | |
| | furilazole | | | | |
| 10 | compound (A-3) | 2.2 | — | 30 | 50 |
| | (A-3) + (S11-2) | 2.2 | 100 | 15 | |
| | fluxofenim | | | | |
| 10 | compound (A-3) | 2.2 | — | 30 | 100 |
| | (A-3) + (S1-7) | 2.2 | 100 | 0 | |
| | fenchlorazole(-ethyl) | | | | |

Notes:
DAT = days after treatment (time of assessment); [g of ai/ha] = gramm of active substance per hectare

1. A herbicide/safener combination comprising components (A) and (B), where
(A) denotes one or more compounds or salts thereof from the group described by the general formula (I): 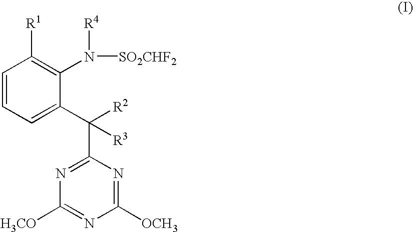
in which
R¹ is halogen, preferably fluorine or chlorine,
R² is hydrogen and R³ is hydroxyl or
R² and R³ together with the carbon atom to which they are attached are a carbonyl group C═O and
R⁴ is hydrogen or methyl;
and
(B) is one or more compounds from the group of the safeners.

2. The herbicide/safener combination as claimed in claim 1, comprising as component (A) one or more of the compounds from the group mentioned below consisting of:

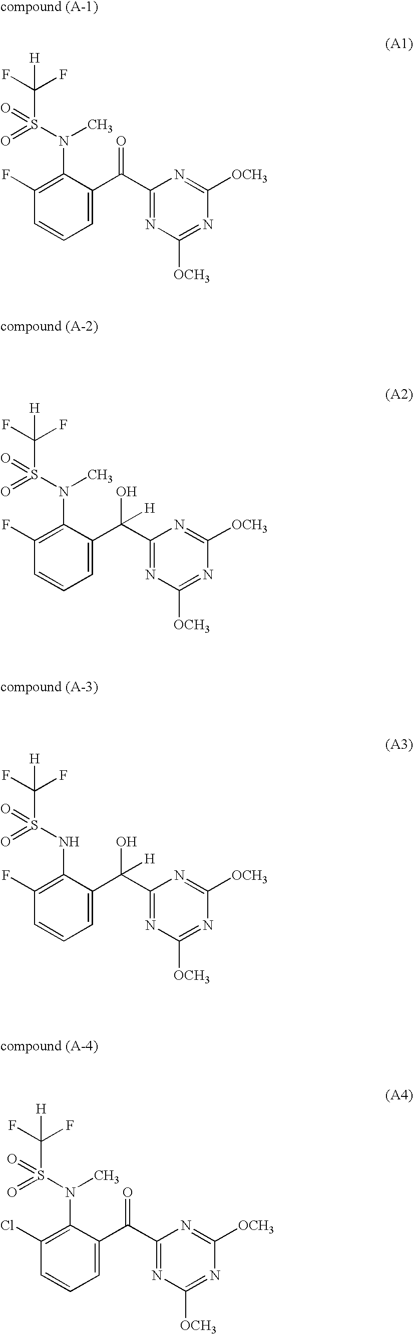

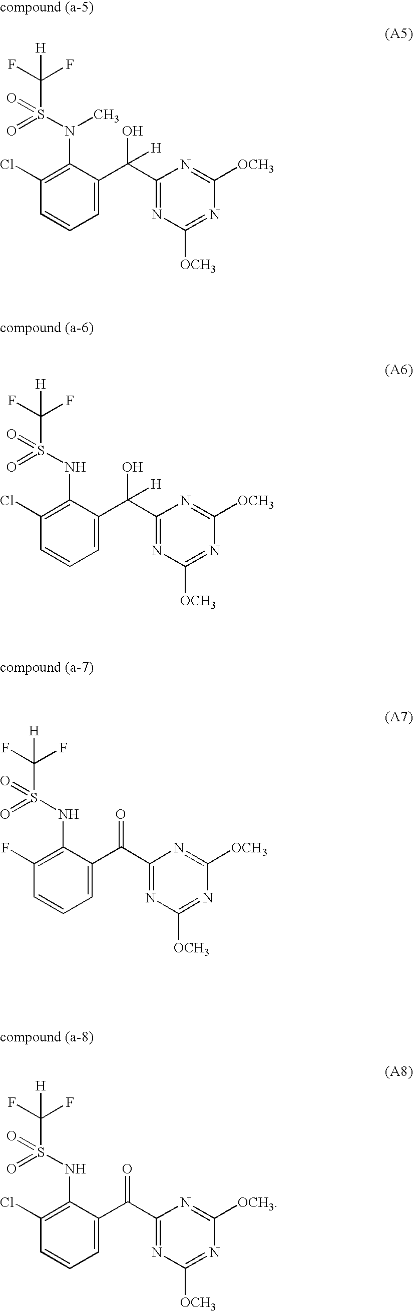

3. The herbicide/safener combination as claimed in claim 1, comprising as component (B) one or more of the compounds from the group mentioned below, including possible stereoisomers and agriculturally customary esters and salts, consisting of:
(S1-1) mefenpyr(-diethyl), (S1-7) fenchlorazole(-ethyl), (S1-12) isoxadifen(-ethyl), (S2-1) cloquintocet(-mexyl), (S3-1) dichlormid, (S3-2) R-29148 (3-dichloroacetyl-2,2,5-trimethyl-1,3-oxazolidine), (S3-3) R-28725 (3-dichloroacetyl-2,2-dimethyl-1,3-oxazolidine), (S3-4) benoxacor, (S3-5) PPG-1292 (N-allyl-N-[(1,3-dioxolan-2-yl)-methyl]dichloroacetamide), (S3-6) DKA-24 (N-allyl-N-[(allylaminocarbonyl)methyl]-dichloroacetamide), (S3-7) AD-67/MON 4660 (3-dichloroacetyl-1-oxa-3-aza-spiro[4,5]decane), (S3-8) TI-35 (1-dichloroacetylazepane), (S3-9) dicyclonon, (S3-10)/(S3-11) furilazole, (S4-1) cyprosulfamide, (S7-1) methyl (diphenylmethoxy)acetate (CAS Reg. No.: 41858-19-9), (S9-1) 1,2-dihydro-4-hydroxy-1-methyl-3-(5-tetrazolylcarbonyl)-2-quinolone (CAS Reg. No.: 95855-00-8), (S11-1) oxabetrinil, (S11-2) fluxofenim, (S11-3) cyometrinil, (S12-1) methyl [(3-oxo-1H-2-benzothiopyran-4(3H)-ylidene)methoxy]acetate (CAS Reg. No.: 205121-04-6), (S13-1) naphthalic anhydride, (S13-2) fenclorim, (S13-3) flurazole, (S13-4) CL-304415 (4-carboxy-3,4-dihydro-2H-1-benzopyran-4-acetic acid), (S13-5) MG-191 (2-dichloromethyl-2-methyl-1,3-dioxolane), (S13-6) MG-838 (2-propenyl 1-oxa-4-azaspiro[4.5]decane-4-carbodithioate), (S13-7) disulfoton (O,O-diethyl S-2-ethylthioethyl phosphorodithioate), (S13-8) dietholate, (S13-9) mephenate; particularly preferably (S1-1) mefenpyr(-diethyl), (S1-7) fenchlorazole(-ethyl), (S1-12) isoxadifen(-ethyl), (S2-1) cloquintocet (-mexyl), (S3-1) dichlormid, (S3-4) benoxacor, (S3-7) AD-67/MON 4660 (3-dichloroacetyl-1-oxa-3-azaspiro[4,5]decane), (S3-8) TI-35 (1-dichloroacetylazepane), (S3-10)/(S3-11) furilazole, (S4-1) cyprosulfamide, (S11-1) oxabetrinil, (S11-2) fluxofenim, (S11-3) cyometrinil, (S13-1) naphthalic anhydride, (S13-2) fenclorim, (S13-3) flurazole; very particularly preferably (S1-1) mefenpyr(-diethyl), (S1-12) isoxadifen(-ethyl), (S2-1) cloquintocet (-mexyl), (S3-1) dichlormid, (S3-4) benoxacor, (S3-7) AD-67/MON 4660 (3-dichloroacetyl-1-oxa-3-azaspiro[4,5]decane), (S3-10)/(S3-11) furilazole, (S4-1) cyprosulfamide, (S11-2) fluxofenim, (S13-2) fenclorim, (S13-3) flurazole.

4. The herbicide/safener combination as claimed in claim 1, where the weight ratio (A):(B) of the components (A) and (B) is in the range of from 1:50000 to 500:1, in particular from 1:8000 to 250:1, very particularly preferably from 1:2500 to 50:1.

5. The herbicide/safener combination as claimed in claim 1, comprising an effective amount of components (A) and (B) and/or additionally one or more further components from the group of agrochemically active compounds of a different type, formulation auxiliaries and additives customary in crop protection.

6. The herbicide/safener combination as claimed in claim 5, where the additional further agrochemically active compound is a herbicide which is structurally different from components (A) and (B).

7. A method for controlling unwanted vegetation, wherein the components (A) and (B) of the herbicide/safener combination, defined according to claim 1, are applied jointly or separately.

8. The method as claimed in claim 7 for controlling unwanted vegetation in crop plants such as wheat (durum wheat and common wheat), corn, soybeans, sugar beet, sugar cane, cotton, rice, beans, flax, barley, oats, rye, triticale, oilseed rape, potatoes, millet (sorghum), pasture grass, greens/lawns, or in fruit plantations, in particular in rice crops.

9. The use of the herbicide/safener combination defined in claim 1 for controlling unwanted vegetation in crop plants, in particular in rice crops.

10. A method for improving crop plant compatibility, wherein the components (A) and (B) of the herbicide/safener combination, defined according to claim 1, are applied jointly or separately.

11. The use of the herbicide/safener combination defined in claim 1 for improving crop plant compatibility, in particular in rice crops.
